(19) United States
(12) Patent Application Publication
(10) Pub. No.: US 2004/0197613 A1
(43) Pub. Date: Oct. 7, 2004

(54) Microfuel cells for use particularly in portable electronic devices and telecommunications devices

(76) Inventors: Patrick Curlier, Boutigny (FR); Jean-Lue Bergamasco, Paris (FR); Tristan Pichonat, Besancon (FR); Manuel Marechal, Saint Martin D'Heres (FR); Bernard Gauthier-Manuel, Besancon (FR); Jean-Yves Sanchez, Saint Ismier (FR)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/407,069

(22) Filed: Apr. 4, 2003

(51) Int. Cl. H01M 8/04

(52) U.S. Cl. 429/14

(57) ABSTRACT

The invention relates to a miniature fuel cell powered by a hydrocarbon fuel making heavy use of micro-technologies in making and assembling the sub-assemblies of the cell. Relative to the prior art, the main innovation consists in using a semiconductor oxidised and made porous in predetermined areas, to receive an electrolytic polymer allowing the composition of the proton exchange membrane necessary for the fuel cell to operate.

### BACKGROUND OF THE INVENTION

The present intervention relates to the field of microfuel cells for use particularly in portable electronic devices, automobile equipment and telecommunications devices.

Miniaturisation of numerous devices, such as mobile phones, computers, personal digital assistants, digital cameras, etc, provokes the need for energy sources of small dimensions and high capacity.

The current solution is the use of batteries. However, the life span of batteries is short, and the need for a recharge of the battery is cumbersome. Indeed, an electrical plug is sometimes hard to find, it is hard to use the portable device during the charging. Furthermore, the batteries are hard to recycle and are an environmental hazard. Plus, the batteries are expensive to make.

Some intents of using fuel cells have been made.

Fuel cells convert the chemical energy stored in a fuel into electrical energy by an electrochemical process which consists in causing a gas or a liquid to react in the presence of an electrolyte, electrodes and a catalyst. More exactly, the catalyst induces the release of electrons from the fuel which circulate from one electrode to the other via an external circuit incorporating the charge while the protons pass through the electrolytic material separating the two electrodes.

Unlike a battery, a fuel cell does not lose its charge or need to be recharged; it operates so long as a fuel and an oxidant are supplied continuously to the cell, by intake from outside. In a standard fuel cell, hydrogen atoms lose their electron at the anode and combine with other electrons and with oxygen from the air at the cathode. Water is the only product generated from the process and the electrodes are not consumed. Conversely, with batteries the electrodes themselves constitute the material participating in the chemical reaction. Compact lithium batteries designed for portable electronic appliances provide an output voltage of about 3 to 4 volts, whereas a basic fuel cell element is not able to develop more than 1 volt. Given its higher power and specific volume, the fuel cell is able to contain more energy in the same volume and the required output voltage can be obtained by putting several basic cell elements in series. Additionally, the fuel cell can be used almost immediately after being recharged with fuel whereas secondary batteries of the lithium-ion type require an immobilisation phase in respect of recharging dependent on their technology.

Miniaturising fuel cells must make it possible to conserve sufficient power and energy, (i.e. low internal impedance), to attain a volume and a mass compatible with their use, and must allow the implementation of an efficient fuel which is able to be diffused in a standard distribution system. Lastly, the microcell manufacturing process must comprise a restricted number of operations compatible with a low production cost.

The membranes of current microcells are constituted by a first polymer generally in the form of a microporous film impregnated with a second polymer. The second polymer—typically Nafion 117 ®—acts as the electrolyte and allows the transport of protons. The solid flexible polymer structure is coated on its two surfaces with a unit constituted by a series of thin layers the function of which is to catalyse the oxidation of the fuel, to transport the electrons to the anode or the cathode, to transport the protons to the membrane, and to provide a maximum tightness seal in respect of liquids (see WO 98/31062). Current microcells are constituted by a stack of membranes and electrodes which are compressed in order to try to guarantee seal tightness.

Nafion 117® is costly. Furthermore, it needs water to operate. Therefore, cells using Nafion 117® impregnated membranes according to the state of the art are slow to start. On top of that, the transverse leaks are impossible to control. It is hard as well to get small devices with this material.

Plus, in these devices, the water contained in the membrane which is required for the transport of the protons, evaporates under the thermal stresses of the operation or the environment. Additionally, the liquid fuel tends to filter through the membrane, which reduces the efficiency of the cell. Lastly, the techniques of assembly used to manufacture current microcells are highly hybridised and require a great number of handling operations.

WO 00/69007 discloses a fuel cell that uses a silicon membrane. The document discloses a fuel cell that uses a porous silicon wafer which is called “wafer silicon membrane”. However, the membrane disclosed in the document is not used as the electrolyte membrane of the fuel cell, but as an electrode. Therefore, the fuel cell always has to use a proton exchange membrane based on a polymer film.

Another solution proposed is the making of dynamic membranes. Such examples of membranes are disclosed in WO 01/15 253. The membranes in this document are in liquid state and make the miniaturization difficult.

The cell proposed in the context of the present intervention allows all these drawbacks to be overcome.

### a. BRIEF SUMMARY OF THE INVENTION.

The subject of the present intervention is a cell including an oxygen electrode and a fuel electrode framing a membrane composed of a microporous medium impregnated with an electrolytic polymer, said cell being fed by an air source and a fuel source. The microporous medium is composed of a semiconductor.

The semiconductor used as the solid medium of the electrolytic membrane makes it possible to control the porosity percentage and the pore dimensions, which are thus able to constitute a very effective barrier to the water molecules included in the membrane and to the fuel molecules. Moreover, the use of a semiconductor provides surfaces of quality for depositing the electrodes.

Using a semiconductor also allows processes to be implemented which call on micro-technologies—in respect of machining and depositing metal films—and on conventional bounding techniques. Micro-technologies allow multilayer metal depositions of optimised thickness to be obtained. Integration of the electronic circuits of management of the energy is possible.

The industrial techniques allow a low cost of production. The potential for mass micro-production from wafers made of semiconductor materials allows a restricted number of hybridisation operations to be implemented compatible with low production costs.

Microcells according to the invention can be manufactured in series using the automated means of the semiconductor industry. The size and geometrical layout of the cell elements can be easily adapted. Lastly microcells manufactured in this way can be directly integrated into powered electronics.

Using an electrolytic membrane comprising a semiconductor medium allows the internal impedance of the cell to be reduced thanks to the reduced membrane thickness. Additionally a perfect fuel tightness, and seal tightness against the water contained in the membrane is guaranteed, so that long-term operation of the cell in a fluctuating environment is conceivable.

The polymer membrane has to be thick enough to keep good mechanical properties (typically 7 mill inches (178 μm) for Nafion 117®). On the contrary, porous silicon allows reduction of the thickness to a dimension as small as 40 μm.

Moreover, the surfaces of the polymer membrane are even. That is why the exchange surface is only equal to the surface of the membrane. On the contrary, the use of porous silicon allows an irregular and rough surface. This provides a higher exchange surface.

The semiconductor is preferably silicon. It is to advantage used in the form of wafers with standard dimensions 3′ or 5′.

The semiconductor is oxidised to make it electrically insulating and porous in predetermined areas. The porosity is adapted to the molecular size of the electrolytic polymer. It is impregnated with a conventional electrolytic polymer which provides the diffusion of the protons in the membrane. The electrolytic polymer is for example Nafion® 117 or a polymer of similar ionic conductivity.

The electrodes are deposited on the surface of the semiconductor. They are to advantage constituted by a metal conventionally used in electrochemical reactions, permeable to protons, preferably gold or platinum or a conductive mask.

The thickness of the catalyst/electrode complex is optimised in such a way as to ensure the efficiency of the cell and to guarantee the fuel tightness. The seal tightness may be improved by retaining a membrane composed of a stack of basic membranes separated by metal layers permeable to protons and impermeable to fuel.

On the hydrogen fuel side, the electrode is coated with a catalyst like Platinum or Ruthenium and Palladium. According to one embodiment, the catalyst material is deposited in a thin layer on the electrode. To advantage, the catalyst material is deposited in several thin layers the granular structure of which may be different. According to another embodiment, the fuel electrode is coated with a layer of Palladium-doped porous silicon increasing the actual surface of the catalysis.

The fuel is preferably an alcohol, such as methanol diluted in water necessary for the chemical reaction. Low dilutability guarantees high specific energy. Conversely, the low dilutability is not favourable to limiting the poisoning of the catalyst by the CO generated by the chemical reaction.

The cell according to the invention is to advantage equipped with exchanger-distributors for the fuels, oxidants and gases and energy generated by the electrochemical reactions. On the fuel side, evacuating the gases, particularly CO₂ and saturated CO, is designed as a function of the supply connections of an interchangeable reservoir.

Because of the low kinetics of the gases generated by the electrochemical reaction, and in order to limit the dimensions of the exchangers responsible for responding to the thermal management of the cell, a micro-pump of MEMS technology may be used. In the same way, a micro-pump which may be of similar technology will be used to advantage in order to ensure the management of the circulation of the air and water. This contribution of active Microsystems helps in the miniaturisation of the device.

Given the moderate efficiency of the device (between 50 and 60%), the condensed part of the water generated by the reaction may be evaporated following its passage through an exchanger near the active cell elements.

The exchangers may to advantage be composed of glass or silicon or carbon or a technical plastic.

Cells according to the invention may be equipped with a heating device in the event of the water contained in the membrane freezing. This device is to advantage located on the periphery of the cell elements in the non-thinned out part of the oxidised silicon. It is constituted by a metal film through which a light current passes. This current may come from a backup secondary battery constantly powered by the cell.

The cell is to advantage constituted by a group of basic cell elements. The semiconductor medium is worked from a standard wafer according to the geometry required. It is oxidised and made porous in the relevant areas, so as to obtain the mechanical, thermal and electrical functionalities necessary for the cell to operate. The number in the group of basic cell elements is adapted to the power requirements. It may then be encapsulated in the exchanger-distributors described above.

The electrolytic membrane composed of a semiconductor medium impregnated with an electrolytic polymer may be integrated into a bipolar or unipolar architecture.

The cell according to the invention is particularly adapted to powering low-consumption portable electronic devices called nomads.

In preferred embodiments for the porous membrane, silicon is made porous by electrochemical anodisation. The membrane shows an important specific surface with a high surface roughness. The exchange surface is therefore much higher than the area of the membrane. In the method used to make the porous membrane, silicon is coated by a native silicon dioxide layer, which is electrically insulating. Therefore, the thickness of the membrane can be less than the usual 100 μm thick membrane. The thickness of the membrane can therefore be around 40 μm for example. The only limit to the thickness is the mechanical stiffness of the membrane.

The diameter of the channels and the porosity of the membrane are defined by the conditions of anodisation and can be chosen as wanted.

In some preferred embodiments, the transfer of the protons is obtained thanks to the proton conductivity of molecules which are bonded to the surface of the channels by covalent bonding. The molecules suitable for such bonding are molecules that have an acid group or a sulphonate group. They are bonded on all the surface of the porous silicon.

In some preferred embodiments, the impregnation by capillarity of polymers or monomers that can be polymerised afterwards is however still possible, of course. The used polymers can conduct protons, like perfluorosulphonate polymers (as Nafion 117®, Flemion® or Aciplex®) or other materials, such as for example siloxanes, sulphones, etherketone sulphonated polymers.

The electrodes that can also act as catalysts are made by spraying of a really thin layer of platinum on the rough surfaces of the membrane.

### a. BRIEF DESCRIPTION OF THE DRAWING.

The invention is illustrated by the following figures without being restricted thereto.

FIG. 1 is a diagrammatic view showing a mobile telephone with a built-in cell according to one possible embodiment of the invention.

FIG. 2 is an exploded perspective view of the cell shown in FIG. 1.

FIG. 3a is a diagrammatic view of the cell in cross-section.

FIG. 3b is a cross-section view along the line AA in FIG. 3a.

FIG. 3c is a view from above of the cell in FIG. 3a.

FIGS. 4a and 4b are enlarged views of the transverse cross-section of a cell according to the invention, at the level of the electrolytic membrane.

FIG. 5a is a view from below of the air/cathode distribution system.

FIG. 5b is a view from above of the fuel anode distribution system.

FIG. 6 is a perspective view of the assembled cell.

FIG. 7 is a schematic longitudinal view of a membrane having channels of different diameters.

FIG. 8 is a schematic bloc diagram showing the steps of a method for making a preferred porous silicon membrane according to a first embodiment.

FIG. 9 is a schematic representation of the steps of a method for making a porous silicon membrane according to FIG. 8.

FIG. 10 is a schematic longitudinal view of the steps for the filling of the channels of the first preferred embodiment of the invention.

FIG. 11 is a schematic bloc diagram showing the steps of a method for making a preferred porous silicon membrane according to a second embodiment.

FIG. 12 is a schematic representation of the steps of a method for making a porous silicon membrane according to FIG. 11.

FIG. 13 is a schematic longitudinal view of the steps for the filling of the channels of the second preferred embodiment of the invention.

FIG. 14 is a schematic longitudinal view of a third preferred embodiment for a membrane according to the invention.

### a. DETAILED DESCRIPTION OF THE INVENTION.

The cell—given the reference 1—shown in the figures presents a planar architecture and is constituted by an assembly which comprises a membrane and electrodes complex 3c and two elements 3a, 3b forming exchangers/distributors between which said complex 3c is encapsulated.

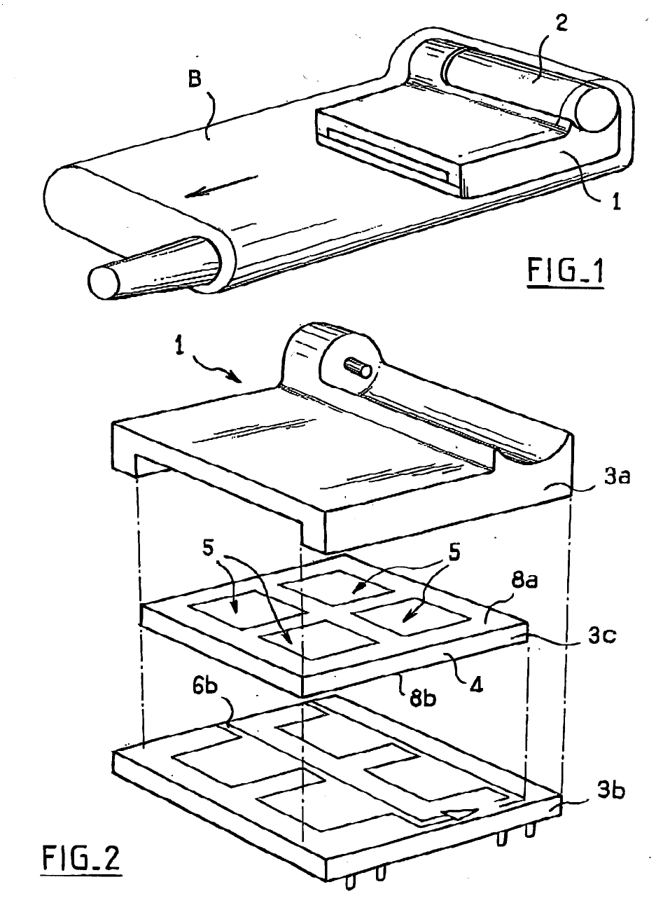

This cell 1 may be—as FIG. 1 shows—a cell integrated in the housing B of a portable telephone. By way of example, it may be able to achieve a 2 volt feed with a power of 2 Watts.

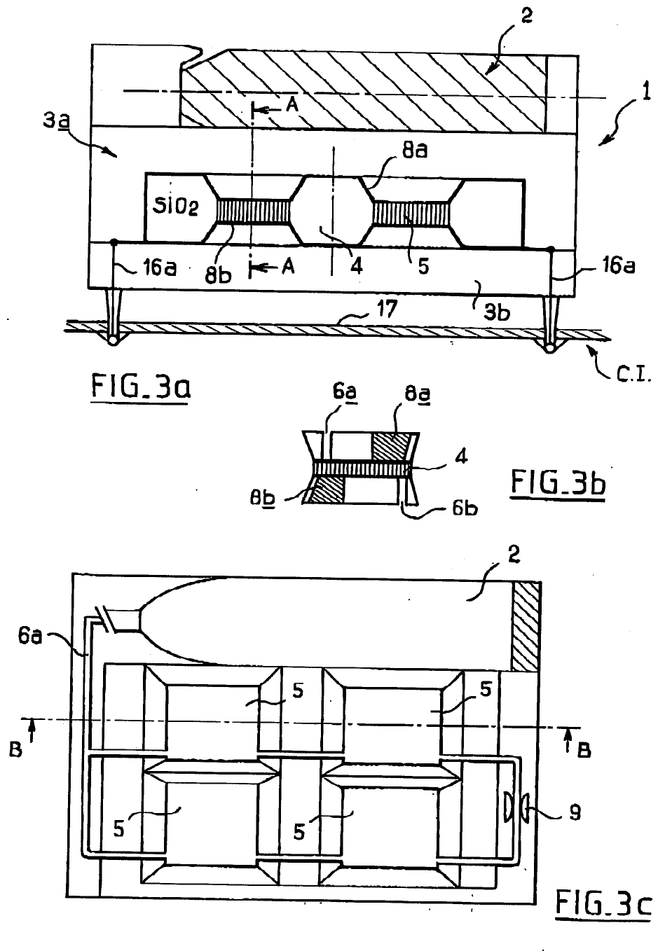

As is shown more exactly in FIGS. 2, 3a to 3c, as well as 4a and 4b the complex 3c is constituted by an anode 8a and a cathode 8b between which a membrane 4 is interposed.

The membrane 4 and the metallised parts 8a, 8b which define the anode 8a and the cathode 8b have, on one side and on the other of the complex 3c, a plurality of recesses which define on the membrane 4 a plurality of cell elements 5 for electrochemical exchanges.

The membrane 4 is constituted by a wafer of an oxidised semiconductor material (oxidised silicon for example), which has been made porous in the areas corresponding to the cell elements 5. This porosity is directed so as to obtain channels which are parallel to each other.

To this end, this membrane 4 is previously processed using masking and etching techniques known conventionally per se in respect of semiconductor materials, so as to obtain in it the recesses corresponding to the cell elements 5, and in the areas corresponding to these cell elements 5, a plurality of micro-channels 11 which pass through the membrane 4 and make it porous, metallised parts corresponding to the electrodes 8a and 8b being then deposited on one side and on the other respectively of the membrane 4.

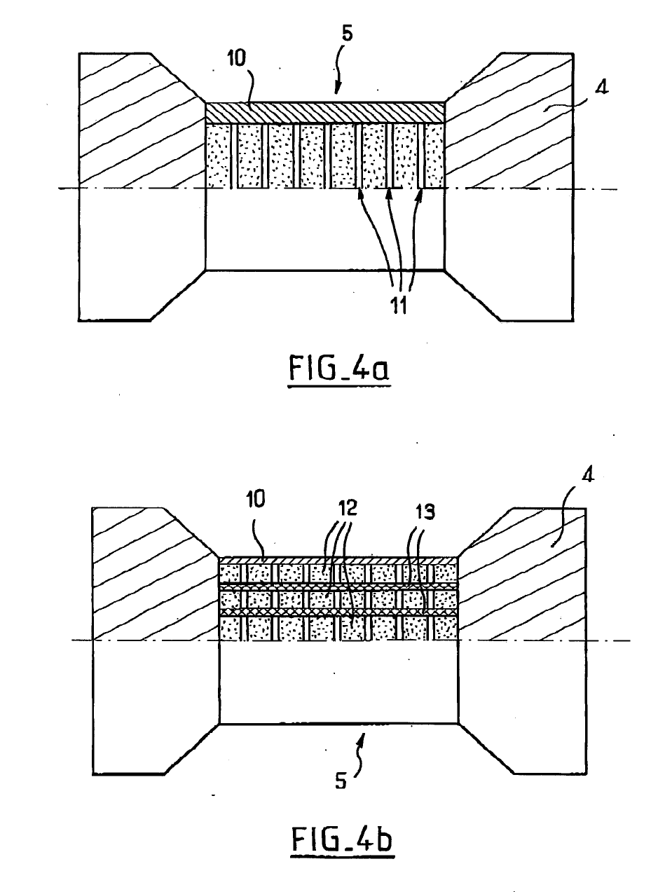

In the example shown in FIG. 4a, the porous semiconductor impregnated with electrolytic polymer is coated with a layer constituted by an electrode-catalyst complex 10.

As an alternative, as shown in FIG. 4b, the membrane 4 is constituted at the level of the cell elements 5 by a complex of basic membranes 12 separated by metal layers 13, the whole being passed through by micro-channels 11 which ensure the passage of the protons.

By referring to FIGS. 2 and 3a to 3c, and FIGS. 5a, 5b it may be understood that the cell elements 5 of the membrane 4 are, at the level of the anode 8a, supplied with fuel through diffusion channels 6a which are provided in the component 3a and which lead the fuel stored in a cartridge 2 to the cell elements 5.

This cartridge 2 is for example cylindrical in shape. It is received in a receptacle provided for this purpose on the exchanger/distributor component 3a.

At the level of the cathode 8b, the cell element 5 of the membrane are supplied with air through diffusion channels 6b which extend through the component 3b and emerge on the one hand in the cell elements 5 and on the other hand outside the component 3b.

The fuel is particularly a methanol/water mixture. The released protons diffuse in the membrane 4 of the basic cell elements 5, whereas the electrons move to the cathode 8b.

CO₂, water and water vapour are released at each cell element 5.

The released CO₂ is evacuated in the exchanger 3a. The water formed at the cathode 8b may be evacuated by evaporation at the exchangers 15 provided for this purpose in the component 3b. In the component 3a, it may be recycled in the distribution system 6, a micro-pump 9 being used to this end to pump this water helped by the kinetics of the water vapour resulting from the exothermic oxidation reaction.

The vertical position of use of the electronic appliance—shown by the arrows in the figures—favours collection in the lower part of the cell elements thus minimising the negative impact of insulation from the presence of water on the active surface of the cell element.

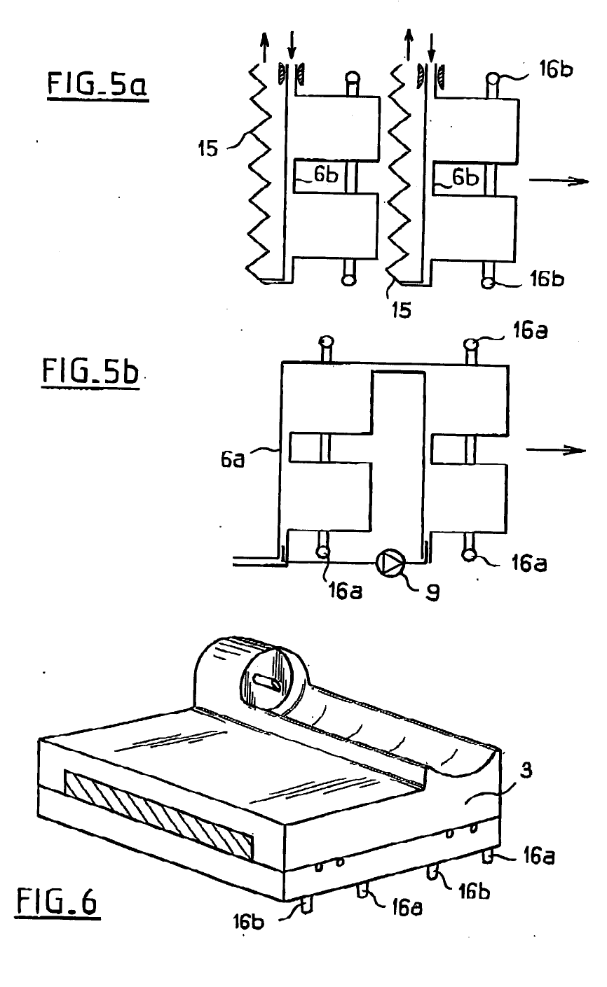

As may be seen more particularly in FIG. 3b, as well as in FIGS. 5a, 5b and 6, metal lugs 16a, 16b are provided on the component 3b forming the exchanger/distributor, which extend through said component 3b and provide the connection of the anode 8a and of the cathode 8b to a printed circuit board 17 which is for example a board which manages the power supply of the mobile telephone B.

Preferentially electrodes are of a highly conductive metal.

In all the following specification, the used abbreviations are as follows.

ATES: allyltriethoxysilane

BTES: benzyltriethoxysilane

ClTMS: chlorotrimethylsilane

OTMS: 7-octenyltriethoxysilane

PTES: phenyltriethoxysilane

TEOS tetraethoxysilane

As described above and shown in FIG. 4a, the membrane used in the cell according to the invention can be a porous silicon membrane 4 impregnated with a proton conductive polymer in the channels 11.

The polymer that is impregnated by capillarity in the channels 11 is already under the form of long chemical chains before getting into the channels 11. Therefore, the polymer has to be diluted in a solvent to be able to enter the channels 11 and form the conductive material.

Several possibilities can be chosen for the polymer to be impregnated in the porous membrane.

The filling of the porosity of silicon by perfluorinated polyelectrolytes with a sulfonic functional group such as Nafion® 117, Aciplex analogs or Dow, or with a carboxylic functional group such as Flemion is possible. Solutions of 5 to 20 mass-% by weight in water/alcohol solvents are introduced in several steps. After passage of the solution, the porous material is heated to eliminate the alcohols. As a result, subsequent passages do not remove the polymer already introduced at previous filling operations. See example 1 and 2.

### EXAMPLE 1

Silicon microporous material is impregnated with Nafion® 117. One 10 μL drop of Nafion® perfluorinated ion-exchange resin at 5 wt % solution in a mixture of lower aliphatic alcohols and water is placed on the silicon microporous material so that it wets the inside space of the microporous material by capillary action. Drying is done under controlled atmosphere at 20° C. and 90% relative humidity. This procedure is repeated on the other surface. The microporous material is then treated with hot 3 mol.L⁻¹ nitric acid over a period of 2 hours then washed in distilled water over a period of two days by means of a Soxhlet. At 25° C. and under 90% relative humidity, a conductivity of 30 mS/cm is obtained.

### EXAMPLE 2

Silicon microporous material is impregnated with Nafion® 117. One 10 μL drop of Nafion® perfluorinated ion-exchange resin at 20 wt % solution in a mixture of lower aliphatic alcohols and water is placed on the silicon microporous material so that it wets the inside space of the microporous material by capillary action. Drying is done under controlled atmosphere at 20° C. and 90% relative humidity. The microporous material is then placed in hot 3 mol.L⁻¹ nitric acid over a period of 2 hours then washed in distilled water over a period of two days by means of a Soxhlet.

The filling of the porosity with a polyelectrolyte having an aromatic main chain such as polysulfones, polyether sulfones, polyether-ether-ketone, polyphenylene oxide, polyphenylene sulfide, ionic group carriers, sulfonic, phosphonic, carboxylic is also possible. The polyelectrolytes can comprise only one of these functional groups or can combine a plurality of these functional groups, e.g. phosphonic/sulfonic, sulfonic/carboxlic, sulfonic/phosphonic/carboxlic. See example 3.

### EXAMPLE 3

2 g of Udel 3500 @ polysulfone are dissolved in 20 ml of dichloroethane. Trimethylsilylchlorosulfonate is added so as to obtain an exchange capacity of 1.8 moles of protons/kg. After precipitation in ethanol, the polyelectrolyte is dissolved in a 4/1 mixture of dichloroethane and isopropanol. Solutions of sulfonated polysulfones are introduced into the porosity of the silicon by capillary action using one 10 μL drop on the surface of the microporous material. The polysulfones used have a sulfonation rate of 1.6 to 1.9 protons per kilogram. After introduction of the polysulfone, conductivities varying between 20 and 70 mS/cm were obtained depending on the sulfonation rate.

The sulphonation can also be done after the introduction of the polymer in the channels. The filling of the porosity can be done on the basis of a polymer having an aromatic main chain such as polysulfone, polyether sulfone, polyether-ether-ketone, polyphenylene oxide, polyphenylene sulfide. After filling of the porosity using the polymer solution, the reagent enabling introduction of the ionic group is introduced into the porosities. The reaction thus takes place in the porosity.

It is time consuming to let the polymer impregnate in the channels 11. Furthermore, the channels 11 have to be large enough to allow the long chemical chains to enter the channels 11. The fact that the channels are of large diameter can provoke leaks of the fuel and/or the oxidant through the membrane.

### DESCRIPTION OF THE PREFERRED EMBODIMENTS

In the preferred embodiments for the silicon porous membrane, the diameter of the channels is reduced, which allows greater tightness with respect to the fuel and/or the oxidant.

Several methods are possible to make the membranes of the preferred embodiments.

In all those methods, the first step is the use of a wafer of doped and oxidized silicon. The thickness of the wafer is for example equal to 500 μm. The second step is the making of square membranes of, for instance, 40 μm in thickness and 3 mm on each side. Of course, the given dimensions are just examples and can be changed depending on the use of the membrane. The making of the thinner membranes out of the wafer is conducted by lithography and chemical etching.

The current collectors for the method are made as soon as this second step by a coating of gold on the oxide layer of the silicon wafer. The collectors are masks for the subsequent step which is the making of the porous silicon by anodisation in a solution. The solution is for example a solution of hydrofluoric acid/water/ethanol. The chemical composition of the solution, the current density of anodisation, the nature and the concentration of the silicon doping agent are important parameters to define the size of the channels and the final porosity.

The beginning of the drilling of the membrane is monitored by a decrease in the tension between the terminals of the anodizer. As the thickness of the membrane is not rigorously the same all over the surface, and as the method of anodisation is not perfectly homogeneous, it is practically impossible to pierce all the channels at the same time.

From that moment, it is not necessary to go on with anodisation, for the majority of the current goes through the opened channels.

Another technique must be employed to etch the rear surface of the membrane and allow the piercing of all the channels. The said other technique is the plasma reactive etching. It gets rid of the few extra microns to open the channel and increases the roughness of the surface.

Then a proton conductive material is introduced in the channels that have been drilled. The material and the technique used are described in more details further down in the specification.

In all the methods used to obtain preferred embodiments, and as it is shown in FIG. 4a, the last step is the coating of the surfaces of the membrane 4 by a catalyst 10. At that stage, all the channels 11 are already filled with conductive material.

A thin layer 10 of platinum is coated by cathodic spraying on the two surfaces of the silicon porous membrane 4. This layer 10 must however be thick enough to allow the conduction of the electrons till the current collector. The coating is made so as to be above the threshold of percolation.

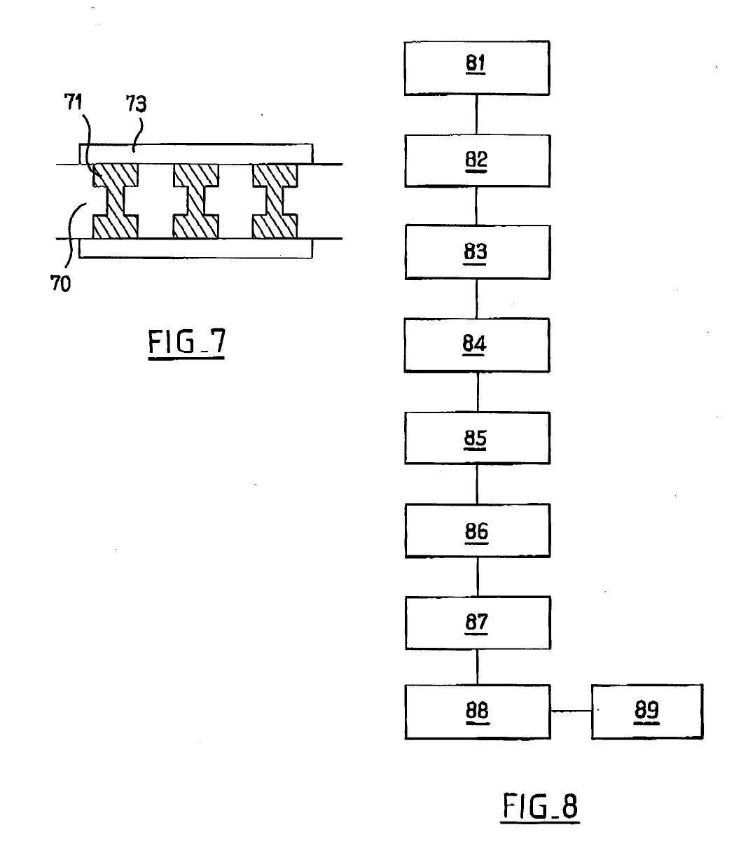

It is also possible to structure the porous medium that is shaped through its thickness. For example, as it is shown in FIG. 7, it is possible to make channels 71 having a small diameter at the centre of the membrane 70 and channels having a larger diameter on the outer surface of the membrane 70. The large diameters are better adapted to the catalyst 73.

First Preferred Embodiment.

Here is described an example of a method to obtain a membrane according to the first preferred embodiment.

The first example of preferred embodiment described here is a silicon porous membrane made by intrinsic anodisation. The porous membrane is obtained by anodisation. The membrane is impregnated by a monomer of Nafion 117® as will be explained further in the specification.

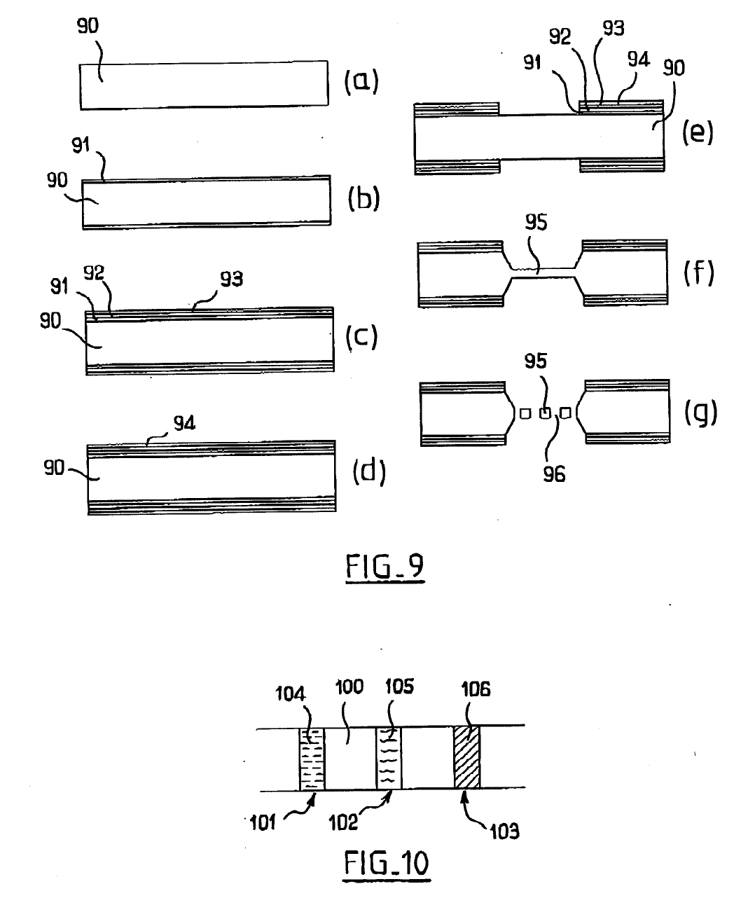

The different steps of the method are as follows, and are shown in FIG. 8 and FIG. 9.

In the first step 81 of FIG. 8, shown as well in FIG. 9(a), an N-type blank wafer 90 of silicon is prepared. The wafer 90 is <100> oriented, and the resistivity of the wafer 90 is from 0.3 to 1 _.cm for example.

In step 82, the wafer 90 is oxidized by a thermal oxidizing, in an oven, at a temperature of 1000° C. for instance. A flux of oxygen and water vapour flows in the oven. The resulting layer of silicon oxide is referred to as 91 in FIG. 9(b).

In step 83, shown in FIG. 9(c), a layer 92 of chromium is coated on each surface of the wafer. The coating is conducted by cathodic spraying. The layer 92 has for example a thickness of 150 nm. This layer 92 serves as a layer of hanging-up for a layer 93 of gold. The layer of gold is for instance 1 μm-thick. The coating of the gold layer 93 is made thanks to a cathodic spraying as well.

In step 84, a photolithography is realised on the wafer 90 which has been metallized in step 83. The photolithography is realised on each of the surface thanks to a chromed glass mask. A photosensitive resin 94 is firstly coated on the wafer 90, above the gold layer 93, as shown in FIG. 9(d). The patterns of the mask are then reproduced by exposure of the resin 94 to ultraviolet radiation. The exposed parts of the resin 94 are then removed in an adapted solvent. The metal layer 93 is therefore bare on the desired locations for the membranes.

In step 85, the bare patterns are then etched by adapted etching solutions. The layers of gold 93, chromium 92 and silicon dioxide 91 are therefore etched. The result of such etchings is shown in FIG. 9(e). The etching of the silicon dioxide 91 is done in an ammonium bifluoride (BHF) solution (7 vol. NH₄F 40%+1 vol HF 50%). The etching of the silicon membrane 90 is done is a KOH solution, with a concentration of 41%. A 40 μm-thick membrane 95 is obtained and the result of such an etching is shown in FIG. 9(f). The resin is also removed at that stage.

In step 86, the drilling of the membrane 95 is done so as to make the membrane 95 porous. The drilling is made by anodisation without current thanks to the potential difference between the remaining gold layer 93 and the silicon in a bath composed of HF:ethanol:water:hydrogen dioxide. The proportions of each component can be, for instance, 9:4:11:1. The result of the drilling is the channels 96 which are shown in FIG. 9(g).

In a step 87, the channels 96 are then made hydrophilic thanks to two successive treatments. The membrane 95 is firstly put in a solution containing 80% of sulphuric acid and 20% of hydrogen peroxide. The membrane stays in the solution during around 60 minutes. Secondly, the membrane is put in a container where each surface is exposed to ultraviolet rays and an ozone flux. The exposure of each surface lasts around 10 minutes.

In step 88, the channels 96 are impregnated by capillarity with 10 μl of a 5% solution of Nafion 117 ®. This kind of solution can be encountered under the Fluka brand.

As explained above, to advantage, the solution contains a monomer instead of a polymer.

FIG. 10 illustrates the steps of such a method. A membrane 100 has channels, referred to as 101, 102 and 103 for example, which are obtained for example by the anodisation technique described above.

According to this method, the material that is the proton conductive material is entered in the channels 101, 102 and 103 under the form of a monomer or oligomer 104.

The three channels 101, 102 and 103 schematically refer to different steps of transformation of the proton conductive material of the first preferred embodiment. In the channel 101, the monomer 104 is introduced in the channels. The introduction can be done by impregnation by capillarity for instance. The channel 102 represents schematically the step when the monomer starts to get cross-linked in the channels. This cross-linking of the monomer is made by the use of heat and/or catalysts. The channel 103 represents the last step of the transformation of the proton conductive material. In this last step, the material is now under the form of a polymer 106 due to cross-linking. The polymer 106 is now in the solid state and blocks the channels 101, 102, 103. The protons are conducted by the polymer 106 through the membrane 100. The membrane 100 is tight to the fuel and/or the fuel oxidizer.

Therefore, the membrane 100 obtained by this method is the same as the embodiment shown in FIG. 4a. However, the diameter of the channels 101, 102 and 103 can be reduced, since the material is introduced in the channel as a monomer. The impregnation is quicker as well. The typical size of the channels is under 100 nm and can be of the order of magnitude of 25-30 nm in some applications.

Referring again to FIG. 8, in step 89, a thin layer of platinum is coated by cathodic spraying on each surface of the membrane to get an electrode 10 as shown in FIG. 4a. The thickness of the layer is equal to 1 to 2 nm. Each layer is therefore an electrode and a catalyst.

The monomer or oligomer 104 introduced in the channel 101 can be a pure monomer or a co-monomer. In the latter case, the polymer 106 obtained will be a copolymer. Here is listed a number of different examples for the monomer or oligomer.

First, the filling of the porosities of silicon by oligomers having a polysiloxane main chain bearing sulfonic functions, in the form of acid or alkali, in concentrated solution or in molten form, in the presence of an initiator enabling post-polymerization after filling the porosity is possible. The cross-linking can be induced by heating above the temperature of decomposition of the initiator, or by UV irradiation, electron bombardment, etc. See examples 4 to 18.

### EXAMPLE 4

Different proportions were used for obtaining copolymers of BTES/ATES: 5, 10 and 15 mole % of ATES, using 10⁻² mole of BTES. The synthesis starts by hydrolysis of half of the ethoxy groups. The polycondensation that follows is catalyzed by the fluoride (F⁻) ion. The NH₄F solution is obtained by dissolving 6 g of NH₄F in 100 mL of methanol. After agitation at room temperature for 3 hours, the excess NH₄F is filtered. The solution is maintained under agitation at room temperature for 48 hours, during which the polymer precipitates. The precipitate is re-dissolved in dichloromethane and the solution is filtered in order to remove the residual NH₄F. The dichloromethane and the methanol are removed by rotary evaporation. Polycondensation is continued for 48 hours at 60° C. The copolymer is re-dissolved in dichloromethane and the residual silanol functional groups are blocked by the addition of 10⁻³ moles of ClTMS. The copolymers obtained are characterized, in solution in tetrahydrofurane, by SEC (size exclusion chromatography) over a set of ultrastyragel columns having a porosity 500, 10³ and 10⁴ Å, the masses being evaluated in polystyrene equivalent, as shown in Table 1.

TABLE 1

| Samples | BTES/ATES (10%) | BTES/ATES (15%) |
|---|---|---|
| M_{w} | 1900 | 3040 |
| Mₙ | 1500 | 2100 |
| I | 1.26 | 1.45 |

M_{w}: average molecular weight in weight
Mₙ: average molecular weight in number
I: polydisperity index

After purification and drying (48 hours at 60° C.), the copolymer is re-dissolved in dichloroethane in a glove box under argon. Sulfonation of the copolymer is done in a glove box over a period of 12 hours under agitation and at room temperature, by the addition drop-wise of trimethylsilylchlorosulfonate (TMSCS) in the proportion of 2 moles of TMSCS per kilogram of copolymer. The trimethylsilyl sulfonate groups are hydrolyzed to sulfonic groups either by contact with atmospheric humidity over the period of 48 hours or by treatment with ethanol. Once purified, a 50 mass % of sulfonated copolymer in dichloroethane is introduced by capillary action into the microporous silicon, one drop being 10 μL. This solution contains 1 mole of dibenzoyl peroxide to 4 moles of double bonds for cross-linking the copolymer by the thermally initiated radical route. Cross-linking is done under argon at 85° C. over a period of 12 hours. The system obtained in this fashion is washed in distilled water over 12 hours.

### EXAMPLE 5

Different proportions were used for obtaining copolymers of BTES/ATES: 5, 10 and 15 mole % of ATES using 10⁻² moles of BTES. The synthesis starts by hydrolysis of half of the ethoxy groups. The polycondensation that follows is catalyzed by the fluoride (F⁻) ion. The NH₄F solution is obtained by dissolving 6 g of NH₄F in 100 mL of methanol. After agitation at room temperature for 3 hours, the excess NH₄F is filtered. The solution is maintained under agitation at room temperature for 48 hours, during which the polymer precipitates. This latter is re-dissolved in dichloromethane and the solution is filtered in order to remove the residual NH₄F. The dichloromethane and the methanol are removed by rotary evaporation. The copolymer obtained is dried and polycondensation done over a period of 48 hours at 60° C. The copolymer is re-dissolved in dichloromethane and the uncondensed hydroxyls are fixed by the addition of 10⁻³ moles of ClTMS. After purification and drying (48 hours at 60° C.), the copolymer is re-dissolved in dichloroethane in the glove box (inert atmosphere/argon). Sulfonation of the copolymer is done using trimethylsilylchorosulfonate, 2 moles per kilogram of copolymer in the glove box over a period of 12 hours under agitation and at room temperature. The trimethylsilyl sulfonate groups are hydrolyzed to sulfonates in air over a period of 48 hours. Once purified, a 50 mass % of sulfonated copolymer in dichloroethane is introduced by capillary action into the microporous silicon, one drop being 10 μL. This solution contains 1 mole of dibenzoyl peroxide to 4 moles of double bonds for cross-linking by the thermally initiated radical route and one mole of 1,7-octadiene to two moles of ATES. Cross-linking is done under argon at 85° C. over a period of 12 hours. The system obtained in this fashion is washed in distilled water over a period of 12 hours.

### EXAMPLE 6

Different proportions were used for obtaining BTES/ATES copolymers: 5, 10 and 15 mole % of ATES using 10⁻² moles of BTES. The synthesis starts by hydrolysis of half of the ethoxy groups. The polycondensation that follows is catalyzed by the fluoride (F⁻) ion. The NH₄F solution is obtained by dissolving 6 g of NH₄F in 100 mL of methanol. After agitation at room temperature for 3 hours, the excess NH₄F is filtered. The solution is maintained under agitation at room temperature for 48 hours, during which the polymer precipitates. This latter is re-dissolved in dichloromethane and the solution is filtered in order to remove the residual NH₄F. The dichloromethane and the methanol are removed by rotary evaporation. The copolymer obtained is dried and polycondensation done over a period of 48 hours at 60° C. The copolymer is re-dissolved in dichloromethane and the uncondensed hydroxyls are fixed by the addition of 10⁻³ moles of ClTMS. The copolymers obtained are characterized by dry size exclusion chromatography (SEC) in tetrahydrofurane, the masses being evaluated in styrene equivalent. After purification and drying (48 hours at 60° C.), the copolymer is re-dissolved in dichloroethane in the glove box (inert atmosphere/argon). Sulfonation of the copolymer is done using trimethylsilylchorosulfonate, 2 moles per kilogram of copolymer in the glove box over a period of 12 hours under agitation and at room temperature. The trimethylsilyl sulfonate groups are hydrolyzed to sulfonates in air over a period of 48 hours. Once purified, a 50 mass % of sulfonated copolymer in dichloroethane is introduced by capillary action into the microporous silicon, one drop being 10 μL. This solution contains 10⁻³ moles of Irgacure® 1959 (CIBA), a photoinitiator having its extinction zone around 275 nm. The copolymer is thus cross-linked by radical photoinitiation. Cross-linking is done under UV and argon over a period of 10 minutes after having evaporated the major part of the solvent. The system is then placed for 2 days in an oven at 75° C. The system obtained in this fashion is washed in distilled water over 12 hours.

### EXAMPLE 7

Different proportions were used for obtaining copolymers of BTES/ATES: 5, 10 and 15 mole % of ATES using 10⁻² moles of BTES. The synthesis starts by hydrolysis of half of the ethoxy groups. The polycondensation that follows is catalyzed by the fluoride (F⁻) ion. The NH₄F solution is obtained by dissolving 6 g of NH₄F in 100 mL of methanol. After agitation at room temperature for 3 hours, the excess NH₄F is filtered. The solution is maintained under agitation at room temperature for 48 hours, during which the polymer precipitates. This latter is re-dissolved in dichloromethane and the solution is filtered in order to remove the residual NH₄F. The dichloromethane and the methanol are removed by rotary evaporation. The copolymer obtained is dried and polycondensation done over a period of 48 hours at 60° C. The copolymer is re-dissolved in dichloromethane and the uncondensed hydroxyls are fixed by the addition of 10⁻³ moles of ClTMS. Once purified, the product is dried at 100° C. under vacuum. The copolymer obtained in this fashion is re-dissolved in the glove box under argon in dichloromethane in order to obtain a 50 mass % solution. This solution contains 10⁻³ moles of Irgacure® 1959 (CIBA), a photoinitiator having its extinction zone around 275 nm. The copolymer is thus cross-linked by the photochemically initiated radical route. Cross-linking is done under UV and argon over a period of 10 minutes after having allowed a large portion of the solvent to escape after the introduction of 10 μL of solution into the microporous silicon material by capillary action. The system obtained is sulfonated with chlorosulfonic acid, 2 moles per kilogram of copolymer with a 10 mole % excess, in the glove box over a period of 12 hours without agitation, at room temperature. The system obtained in this fashion is washed in distilled water over a period of 12 hours.

### EXAMPLE 8

Different proportions were used for obtaining copolymers of BTES/OTMS: 5, 10 and 15 mole % of OTMS using 10⁻² moles of BTES. The synthesis starts by hydrolysis of half of the ethoxy groups. The polycondensation that follows is catalyzed by the fluoride (F⁻) ion. The NH₄F solution is obtained by dissolving 6 g of NH₄F in 100 mL of methanol. After agitation at room temperature for 3 hours, the excess NH₄F is filtered. The solution is maintained under agitation at room temperature for 48 hours, during which the polymer precipitates. This latter is re-dissolved in dichloromethane and the solution is filtered in order to remove the residual NH₄F. The dichloromethane and the methanol are removed by rotary evaporation. The copolymer obtained is dried and polycondensation is done over 48 hours at 60° C. The copolymer is re-dissolved in dichloromethane and the uncondensed hydroxyls are fixed by the addition of 10⁻³ moles of ClTMS. The copolymers obtained are characterized by size exclusion chromatography (SEC) in tetrahydrofurane, the masses being evaluated in styrene equivalent, as shown in Table 2.

TABLE 2

| Samples | BTES/OTMS (10%) | BTES/OTMS (15%) |
|---|---|---|
| Mw | 4300 | 5760 |
| Mn | 2520 | 3140 |
| I | 1.70 | 1.84 |

After purification and drying (48 hours at 60° C.), the copolymer is re-dissolved in dichloroethane in the glove box (inert atmosphere/argon). Sulfonation of the copolymer is done using trimethylsilylchorosulfonate, 2 moles per kilogram of copolymer in the glove box over a period of 12 hours under agitation and at room temperature. The trimethylsilyl sulfonate groups are hydrolyzed to sulfonates in air over a period of 48 hours. By modulated DSC, the vitreous transition temperature (with the initial copolymer in 15% of OTMS) at 2° C. min⁻¹ with variations of amplitude of ±1° C. min⁻¹ and of period of 60 seconds, by assuming the valley of the transition to be 258 K. Once purified, a 50 mass % of sulfonated copolymer in dichloroethane is introduced by capillary action into the microporous silicon, one drop being 10 μL. This solution contains 1 mole of dibenzoyl peroxide to 4 moles of double bonds for cross-linking the copolymer by the thermally initiated radical route. Cross-linking is done under argon at 85° C. over a period of 12 hours. The system obtained in this fashion is washed in distilled water over 12 hours.

### EXAMPLE 9

Different proportions were used for obtaining copolymers of BTES/OTMS: 5, 10 and 15 mole % of OTMS using 10⁻² moles of BTES. The synthesis starts by hydrolysis of half of the ethoxy groups. The polycondensation that follows is catalyzed by the fluoride (F⁻) ion. The NH₄F solution is obtained by dissolving 6 g of NH₄F in 100 mL of methanol. After agitation at room temperature for 3 hours, the excess NH₄F is filtered. The solution is maintained under agitation at room temperature for 48 hours, during which the polymer precipitates. This latter is re-dissolved in dichloromethane and the solution is filtered in order to remove the residual NH₄F. The dichloromethane and the methanol are removed by rotary evaporation. The copolymer obtained is dried and polycondensation done over a period of 48 hours at 60° C. The copolymer is re-dissolved in dichloromethane and the uncondensed hydroxyls are fixed by the addition of 10⁻³ moles of ClTMS. After purification and drying (48 hours at 60° C.), the copolymer is re-dissolved in dichloroethane in the glove box (inert atmosphere/argon). Sulfonation of the copolymer is done using trimethylsilylchorosulfonate, 2 moles per kilogram of copolymer in the glove box over a period of 12 hours under agitation and at room temperature. The trimethylsilylsulfonate groups are hydrolyzed to sulfonates in air over a period of 48 hours. Once purified, a 50 mass % of sulfonated copolymer in dichloroethane is introduced by capillary action into the microporous silicon, one drop being 10 μL. This solution contains 1 mole of dibenzoyl peroxide to 4 moles of double bonds and one mole of 1,7-octadiene to two moles of OTMS is added for cross-linking by the thermally initiated radical route. Cross-linking is done under argon at 85° C. over a period of 12 hours. The system obtained in this fashion is washed in distilled water over 12 hours.

### EXAMPLE 10

Different proportions were used for obtaining copolymers of BTES/OTMS 5, 10 and 15 mole % of OTMS using 10⁻² moles of BTES. The synthesis starts by hydrolysis of half of the ethoxy groups. The polycondensation that follows is catalyzed by the fluoride (F⁻) ion. The NH₄F solution is obtained by dissolving 6 g of NH₄F in 100 mL of methanol. After agitation at room temperature for 3 hours, the excess NH₄F is filtered. The solution is maintained under agitation at room temperature for 48 hours, during which the polymer precipitates. This latter is re-dissolved in dichloromethane and the solution is filtered in order to remove the residual NH₄F. The dichloromethane and the methanol are removed by rotary evaporation. The copolymer obtained is dried and polycondensation done over a period of 48 hours at 60° C. The copolymer is re-dissolved in dichloromethane and the uncondensed hydroxyls are fixed by the addition of 10⁻³ moles of ClTMS. After purification and drying (48 hours at 60° C.), the copolymer is re-dissolved in dichloroethane in the glove box (inert atmosphere/argon). Sulfonation of the copolymer is done using trimethylsilylchorosulfonate, 2 moles per kilogram of copolymer in the glove box over a period of 12 hours under agitation and at room temperature. The trimethylsilyl sulfonate groups are hydrolyzed to sulfonates in air over a period of 48 hours. Once purified, a 50 mass % of sulfonated copolymer in dichloroethane is introduced by capillary action into the microporous silicon, one drop being 10 μL. This solution contains 10⁻³ moles of Irgacure® 1959 (CIBA), a photoinitiator having its extinction zone around 275 nm. The copolymer is thus cross-linked by the photochemically initiated radical route. Cross-linking is done under UV and argon over a period of 10 minutes after having allowed the major part of the solvent to escape. The system is then placed for 2 days in an oven at 75° C. The system thus obtained is washed in distilled water for 12 hours.

### EXAMPLE 11

Different proportions were used for obtaining copolymers of BTES/ATES: 5, 10 and 15 mole % of OTMS using 10⁻² moles of BTES. The synthesis starts by hydrolysis of half of the ethoxy groups. The polycondensation that follows is catalyzed by the fluoride (F⁻) ion. The NH₄F solution is obtained by dissolving 6 g of NH₄F in 100 mL of methanol. After agitation at room temperature for 3 hours, the excess NH₄F is filtered. The solution is maintained under agitation at room temperature for 48 hours, during which the polymer precipitates. This latter is re-dissolved in dichloromethane and the solution is filtered in order to remove the residual NH₄F. The dichloromethane and the methanol are removed by rotary evaporation. The copolymer obtained is dried and polycondensation done over a period of 48 hours at 60° C. The copolymer is re-dissolved in dichloromethane and the uncondensed hydroxyls are fixed by the addition of 10⁻³ moles of ClTMS. After purification and drying (48 hours at 60° C.), the copolymer is re-dissolved in dichloroethane in the glove box (inert atmosphere/argon). Sulfonation of the copolymer is done using trimethylsilylchorosulfonate, 2 moles per kilogram of copolymer in the glove box over a period of 12 hours under agitation and at room temperature. The trimethylsilyl sulfonate groups are hydrolyzed to sulfonates in air over a period of 48 hours. Once purified, a 50 mass % of sulfonated copolymer in dichloroethane is introduced by capillary action into the microporous silicon, one drop being 10 μL. This solution contains 10⁻³ moles of Irgacure® 1959 (CIBA), a photoinitiator having its extinction zone around 275 nm and one mole of 1,7-octadiene to two moles of OTMS. The copolymer is thus cross-linked by the photochemically initiated radical route. Cross-linking is done under UV and argon over a period of 10 minutes after having allowed the major part of the solvent to escape. The system is then placed for 2 days in an oven at 75° C. The system thus obtained is washed in distilled water for 12 hours.

### EXAMPLE 12

The same protocol as in Example 4 is used by replacing the BTES with PTES.

### EXAMPLE 13

The same protocol as in Example 5 is used by replacing the BTES with PTES.

### EXAMPLE 14

The same protocol as in Example 7 is used by replacing the BTES with PTES.

### EXAMPLE 15

The same protocol as in Example 8 is used by replacing the BTES with PTES.

### EXAMPLE 16

The same protocol as in Example 9 is used by replacing the BTES with PTES.

### EXAMPLE 17

The same protocol as in Example 10 is used by replacing the BTES with PTES.

### EXAMPLE 18

The same protocol as in Example 11 is used by replacing the BTES with PTES.

Of course, there are other possibilities. The same protocol as in Example 6 is used by replacing the BTES with PTES for example.

In examples 4 to 18, the sulphonation is done before the monomer or oligomer is introduced in the channels or porosity. The sulphonation can be done after the filling of the channels or porosity.

In the following example, the filling of the porosity of the silicon is done using oligomers having a polysiloxane main chain, in concentrated solution or in the molten state, in the presence of an initiator enabling post-polymerization after filling of the porosity. After thermal or photochemical cross-linking the reagent enabling introduction of the ionic group is introduced into the porosity. The reaction thus takes place in the porosity. See examples 19 to 38.

### EXAMPLE 19

Different proportions were used for obtaining copolymers of BTES/ATES: 5, 10 and 15 mole % of ATES using 10⁻² moles of BTES. The synthesis starts by hydrolysis of half of the ethoxy groups. The polycondensation that follows is catalyzed by the fluoride (F⁻) ion. The NH₄F solution is obtained by dissolving 6 g of NH₄F in 100 mL of methanol. After agitation at room temperature for 3 hours, the excess NH₄F is filtered. The solution is maintained under agitation at room temperature for 48 hours, during which the polymer precipitates. This latter is re-dissolved in dichloromethane and the solution is filtered in order to remove the residual NH₄F. The dichloromethane and the methanol are removed by rotary evaporation. The copolymer obtained in this fashion is dried and polycondensation done over 48 hours at 60° C. The copolymer is re-dissolved in dichloromethane and the uncondensed hydroxyls are fixed by the addition of 10⁻³ moles of ClTMS. Once purified, the product is dried at 100° C. under vacuum. The copolymer obtained in this fashion is re-dissolved in the glove box under argon in dichloromethane in order to obtain a 50 mass-% solution. This solution contains 1 mole of dibenzoyl peroxide to 4 moles of double bonds for cross-linking the copolymer by thermally initiated radical means. Cross-linking is done under argon at 85° C. over a period of 12 hours after introduction of 10 μL of solution by capillary action into silicon microporosities. The system obtained is sulfonated with chlorosulfonic acid, 2 moles per kilogram of copolymer with a 10 mole % excess, in the glove box over a period of 12 hours at room temperature. The system obtained in this fashion is washed in distilled water over 12 hours. The system obtained using copolymer with 10 mole % ATES has a conductivity of 2*10⁻² S.cm⁻¹.

### EXAMPLE 20

Different proportions were used for obtaining copolymers of BTES/OTMS: 5, 10 and 15 mole % of OTMS using 10⁻² moles of BTES. The synthesis starts by hydrolysis of half of the ethoxy groups. The polycondensation that follows is catalyzed by the fluoride (F⁻) ion. The NH₄F solution is obtained by dissolving 6 g of NH₄F in 100 mL of methanol. After agitation at room temperature for 3 hours, the excess NH₄F is filtered. The solution is maintained under agitation at room temperature for 48 hours, during which the polymer precipitates. This latter is re-dissolved in dichloromethane and the solution is filtered in order to remove the residual NH₄F. The dichloromethane and the methanol are removed by rotary evaporation. The copolymer obtained is dried and polycondensation done over a period of 48 hours at 60° C. The copolymer is re-dissolved in dichloromethane and the uncondensed hydroxyls are fixed by the addition of 10⁻³ moles of ClTMS. Once purified, the product is dried at 100° C. under vacuum. The copolymer obtained in this fashion is re-dissolved in the glove box under argon in dichloromethane in order to obtain a 50 mass-% solution. This solution contains 1 mole of dibenzoyl peroxide to 4 moles of double bonds for cross-linking the copolymer by the thermally initiated radical route. Cross-linking is done under argon at 85° C. over a period of 12 hours after introduction of 10 μL of solution by capillary action into the silicon microporosities. The system obtained is sulfonated with chlorosulfonic acid, 2 moles per kilogram of copolymer with a 10 mole % excess, in the glove box over a period of 12 hours at room temperature. The system obtained in this fashion is washed in distilled water over 12 hours.

### EXAMPLE 21

Different proportions were used for obtaining copolymers of BTES/ATES: 5, 10 and 15 mole % of ATES using 10⁻² moles of BTES. The synthesis starts by hydrolysis of half of the ethoxy groups. The polycondensation that follows is catalyzed by the fluoride (F⁻) ion. The NH₄F solution is obtained by dissolving 6 g of NH₄F in 100 mL of methanol. After agitation at room temperature for 3 hours, the excess NH₄F is filtered. The solution is maintained under agitation at room temperature for 48 hours, during which the polymer precipitates. This latter is re-dissolved in dichloromethane and the solution is filtered in order to remove the residual NH₄F. The dichloromethane and the methanol are removed by rotary evaporation. The copolymer obtained is dried and polycondensation done over a period of 48 hours at 60° C. The copolymer is re-dissolved in dichloromethane and the uncondensed hydroxyls are fixed by the addition of 10⁻³ moles of ClTMS. Once purified, the product is dried at 100° C. under vacuum. The copolymer obtained in this fashion is re-dissolved in the glove box under argon in dichloromethane in order to obtain a 50 mass % solution. This solution contains 10⁻³ moles of Irgacure® 1959 (CIBA), a photoinitiator having its extinction zone around 275 nm. The copolymer is thus cross-linked by the photochemically initiated radical route. Cross-linking is done under UV and argon over a period of 10 minutes after having allowed a large portion of the solvent to escape after the introduction of 10 μL of solution into the microporous silicon material by capillary action. The system obtained is sulfonated with chlorosulfonic acid, 2 moles per kilogram of copolymer with a 10 mole % excess, in the glove box over a period of 12 hours without agitation, at room temperature. The system obtained in this fashion is washed in distilled water over a period of 12 hours.

### EXAMPLE 22

Different proportions were used for obtaining copolymers of BTES/OTMS: 5, 10 and 15 mole % of OTMS using 10⁻² moles of BTES. The synthesis starts by hydrolysis of half of the ethoxy groups. The polycondensation that follows is catalyzed by the fluoride (F⁻) ion. The NH₄F solution is obtained by dissolving 6 g of NH₄F in 100 mL of methanol. After agitation at room temperature for 3 hours, the excess NH₄F is filtered. The solution is maintained under agitation at room temperature for 48 hours, during which the polymer precipitates. This latter is re-dissolved in dichloromethane and the solution is filtered in order to remove the residual NH₄F. The dichloromethane and the methanol are removed by rotary evaporation. The copolymer obtained is dried and polycondensation done over a period of 48 hours at 60° C. The copolymer is re-dissolved in dichloromethane and the uncondensed hydroxyls are fixed by the addition of 10⁻³ moles of ClTMS. Once purified, the product is dried at 100° C. under vacuum. The copolymer obtained in this fashion is re-dissolved in the glove box under argon in dichloromethane in order to obtain a 50 mass % solution. This solution contains 10⁻³ moles of Irgacure® 1959 (CIBA), a photoinitiator having its extinction zone around 275 nm. The copolymer is thus cross-linked by radical photoinitiation. Cross-linking is done under UV and argon over a period of 10 minutes after having allowed a large portion of the solvent to escape after the introduction of 10 μL of solution into the microporous silicon material by capillary action. The system obtained is sulfonated with chlorosulfonic acid, 2 moles per kilogram of copolymer with a 10 mole % excess, in the glove box over a period of 12 hours without agitation, at room temperature. The system obtained in this fashion is washed in distilled water over a period of 12 hours.

### EXAMPLE 23

Different proportions were used for obtaining copolymers of BTES/ATES: 5, 10 and 15 mole % of ATES using 10⁻² moles of BTES. The synthesis starts by hydrolysis of half of the ethoxy groups. The polycondensation that follows is catalyzed by the fluoride (F⁻) ion. The NH₄F solution is obtained by dissolving 6 g of NH₄F in 100 mL of methanol. After agitation at room temperature for 3 hours, the excess NH₄F is filtered. The solution is maintained under agitation at room temperature for 48 hours, during which the polymer precipitates. This latter is re-dissolved in dichloromethane and the solution is filtered in order to remove the residual NH₄F. The dichloromethane and the methanol are removed by rotary evaporation. The copolymer obtained is dried and polycondensation done over a period of 48 hours at 60° C. The copolymer is re-dissolved in dichloromethane and the uncondensed hydroxyls are fixed by the addition of 10⁻³ moles of ClTMS. Once purified, the product is dried at 100° C. under vacuum. The copolymer obtained in this fashion is re-dissolved in the glove box under argon in dichloromethane in order to obtain a 50 mass % solution. This solution contains 1 mole of dibenzoyl peroxide to 4 moles of double bonds and one mole of 1,7-octadiene to two moles of ATES is added for cross-linking by the thermally initiated radical route. Cross-linking is done under argon at 85° C. over a period of 12 hours after introduction of 10 μL of solution by capillary action into silicon microporosities. By modulated DSC, the vitreous transition temperature (with the initial copolymer in 10% ATES) at 2° C. min⁻¹ with variations of amplitude of +1° C. min⁻¹ and 60 seconds of period by assuming the valley of the transition is 290 K. The system obtained is sulfonated with chlorosulfonic acid, 2 moles per kilogram of copolymer with a 10 mole % excess, in the glove box over a period of 12 hours at room temperature. The system obtained in this fashion is washed in distilled water over 12 hours.

### EXAMPLE 24

Different proportions were used for obtaining copolymers of BTES/OTMS: 5, 10 and 15 mole % of OTMS using 10⁻² moles of BTES. The synthesis starts by hydrolysis of half of the ethoxy groups. The polycondensation that follows is catalyzed by the fluoride (F⁻) ion. The NH₄F solution is obtained by dissolving 6 g of NH₄F in 100 mL of methanol. After agitation at room temperature for 3 hours, the excess NH₄F is filtered. The solution is maintained under agitation at room temperature for 48 hours, during which the polymer precipitates. This latter is re-dissolved in dichloromethane and the solution is filtered in order to remove the residual NH₄F. The dichloromethane and the methanol are removed by rotary evaporation. The copolymer obtained is dried and polycondensation done over a period of 48 hours at 60° C. The copolymer is re-dissolved in dichloromethane and the uncondensed hydroxyls are fixed by the addition of 10⁻³ moles of ClTMS. Once purified, the product is dried at 100° C. under vacuum. The copolymer obtained in this fashion is re-dissolved in the glove box under argon in dichloromethane in order to obtain a 50 mass % solution. This solution contains 1 mole of dibenzoyl peroxide to 4 moles of OTMS and one mole of 1,7-octadiene to two moles of OTMS for cross-linking by the thermally initiated radical route. Cross-linking is done under argon at 85° C. over a period of 12 hours after introduction of 10 μL of solution by capillary action into silicon microporosities. The system obtained is sulfonated with chlorosulfonic acid, 2 moles per kilogram of copolymer with a 10 mole % excess, in the glove box over a period of 12 hours at room temperature. The system obtained in this fashion is washed in distilled water over 12 hours.

### EXAMPLE 25

Different proportions were used for obtaining copolymers of BTES/ATES: 5, 10 and 15 mole % of ATES using 10⁻² moles of BTES. The synthesis starts by hydrolysis of half of the ethoxy groups. The polycondensation that follows is catalyzed by the fluoride (F⁻) ion. The NH₄F solution is obtained by dissolving 6 g of NH₄F in 100 mL of methanol. After agitation at room temperature for 3 hours, the excess NH₄F is filtered. The solution is maintained under agitation at room temperature for 48 hours, during which the polymer precipitates. This latter is re-dissolved in dichloromethane and the solution is filtered in order to remove the residual NH₄F. The dichloromethane and the methanol are removed by rotary evaporation. The copolymer obtained is dried and polycondensation done over a period of 48 hours at 60° C. The copolymer is re-dissolved in dichloromethane and the uncondensed hydroxyls are fixed by the addition of 10⁻³ moles of ClTMS. Once purified, the product is dried at 100° C. under vacuum. The copolymer obtained in this fashion is re-dissolved in the glove box under argon in dichloromethane in order to obtain a 50 mass % solution. This solution contains 10⁻³ moles of Irgacure® 1959 (CIBA), a photoinitiator having its extinction zone around 275 nm and one mole of 1,7-octadiene to two moles of ATES. The copolymer is thus cross-linked by the photochemically initiated radical route. Cross-linking is done under UV and argon over a period of 10 minutes after having allowed a large portion of the solvent to escape after the introduction of 10 μL of solution into the microporous silicon material by capillary action. The system obtained is sulfonated with chlorosulfonic acid, 2 moles per kilogram of copolymer with a 10 mole % excess, in the glove box over a period of 12 hours without agitation, at room temperature. The system obtained in this fashion is washed in distilled water over 12 hours.

### EXAMPLE 26

Different proportions were used for obtaining copolymers of BTES/OTMS: 5, 10 and 15 mole % of OTMS using 10⁻² moles of BTES. The synthesis starts by hydrolysis of half of the ethoxy groups. The polycondensation that follows is catalyzed by the fluoride (F⁻) ion. The NH₄F solution is obtained by dissolving 6 g of NH₄F in 100 mL of methanol. After agitation at room temperature for 3 hours, the excess NH₄F is filtered. The solution is maintained under agitation at room temperature for 48 hours, during which the polymer precipitates. This latter is re-dissolved in dichloromethane and the solution is filtered in order to remove the residual NH₄F. The dichloromethane and the methanol are removed by rotary evaporation. The copolymer obtained is dried and polycondensation done over a period of 48 hours at 60° C. The copolymer is re-dissolved in dichloromethane and the uncondensed hydroxyls are fixed by the addition of 10⁻³ moles of ClTMS. Once purified, the product is dried at 100° C. under vacuum. The copolymer obtained in this fashion is re-dissolved in the glove box under argon in dichloromethane in order to obtain a 50 mass % solution. This solution contains 10⁻³ moles of Irgacure® 1959 (CIBA), a photoinitiator having its extinction zone around 275 nm and one mole of 1,7-octadiene to two moles of OTMS. The copolymer is thus cross-linked by the photochemically initiated radical route. Cross-linking is done under UV and argon over a period of 10 minutes after having allowed a large portion of the solvent to escape after the introduction of 10 μL of solution into the microporosity by capillary action. The system obtained is sulfonated with chlorosulfonic acid, 2 moles per kilogram of copolymer with a 10 mole % excess, in the glove box over a period of 12 hours without agitation, at room temperature. The system obtained in this fashion is washed in distilled water over 12 hours.

### EXAMPLE 27

The same protocol as in Example 19 is used by replacing the BTES with PTES.

### EXAMPLE 28

The same protocol as in Example 20 is used by replacing the BTES with PTES.

### EXAMPLE 29

The same protocol as in Example 21 is used by replacing the BTES with PTES.

### EXAMPLE 30

The same protocol as in Example 22 is used by replacing the BTES with PTES.

### EXAMPLE 31

The same protocol as in Example 23 is used by replacing the BTES with PTES.

### EXAMPLE 32

The same protocol as in Example 24 is used by replacing the BTES with PTES.

### EXAMPLE 33

The same protocol as in Example 25 is used by replacing the BTES with PTES.

### EXAMPLE 34

The same protocol as in Example 26 is used by replacing the BTES with PTES.

### EXAMPLE 35

A series of samples of initial compositions in moles of TEOSₙ−BTES₍₁₋ₙ₎ (with n=0.1, 0.4, 1) was synthesized using as the catalyst NH₄F after hydrolysis of half of the ethoxy groups. After 48 hours of reaction at room temperature, the supernatant solution was removed. The precipitate was collected in dichloromethane. The 0 and 20% TEOS samples did not, with the exception of NH₄F, produce any product insoluble in CH₂Cl₂ and there was 40% of insoluble product in the dichloroethane for the 40% samples. For the 40% samples, the insoluble fractions were washed in methanol and the same method was used for pure TEOS.

Two 40% TEOS samples, one 10% TEOS sample and pure TEOS were synthesized using the same catalyst. Two BTES/TEOS (60/40) samples were done at the time of hydrolysis prior to their mixing. For sample A, the two compounds were mixed immediately and for B, hydrolysis continued for about 10 minutes. The results by SEC (size exclusion chromatography) in tetrahydrofurane, the masses being in styrene equivalent, are presented in the following table 3:

TABLE 3

| | BTES/TEOS (90/10), | BTES/TEOS (60/40) | BTES/TEOS(60/40) | Pure |
|---|---|---|---|---|
| Samples | sulfonated | (A) | (B) | TEOS |
| Mw | 1486 | 2889 | 15542 | ** |
| Mn | 1261 | 2017 | 4458 | ** |
| I | 1.18 | 1.43 | 3.49 | ** |

(*: poly pure TEOS does not dissolve in THF)

Thermal analysis by DSC shows that the vitreous transition temperature of the polyTEOS is around 438 K.

After polycondensation over a period of 48 h at 60° C. in the oven, the BTES/TEOS (90/10) and BTES/TEOS (60/40) samples were sulfonated by chlorosulfonic acid, which is introduced typically in the stoichiometry of 20% relative to BTES in dichloromethane. All of the products were immediately precipitated in the solvent. The results of testing of satisfactory or unsatisfactory solvents of sulfonated BTES/TEOS (90/10) are given in the following table 4:

TABLE 4

| Good Solvents | Non-Solvents |
|---|---|
| Ethyl alcohol | Water 25° C. |
| N,N-dimethylformamide dimethyl | Dichloroethane |
| acetal | |
| Methyl sulfoxide | |
| Boiling distilled water | |

40% sulfonated BTES/TEOS does not dissolve in water, ethyl alcohol, dichloromethane, methyl alcohol and acetone. Concentrated solutions of 10% sulfonated BTES/TEOS in the different good solvents were introduced into the space of the microporous silicon material by capillary action by depositing a 10 μL drop. The systems obtained in this fashion were left for one hour in the open air, then washed in distilled water for a period of 12 hours. For 40% BTES/TEOS, copolymerization en masse is done directly in the space of the tube by adding one 10 μL drop of the reaction mixture defined at the beginning of the example. The system obtained is sulfonated using trimethylsilylchlorosulfonate, 2 moles per kilogram of copolymer with an excess of 10 mole % in a glove box for a period of 12 hours by placing one 10 μL drop of the sulfonation agent on the microporous silicon material. The systems obtained in this fashion were left for one hour in the open air, then washed in distilled water for a period of 12 hours in order to obtain sulfonates.

### EXAMPLE 36

A series of samples of initial compositions in moles of TEOSₙ−PTES₍₁₋ₙ₎ (with n=0.1, 0.4, 1) was synthesized using as the catalyst NH₄F after hydrolysis of half of the ethoxy groups. After 48 hours of reaction at room temperature, the supernatant solution was removed. The precipitate was collected in dichloromethane. The 0 and 20% TEOS samples did not, with the exception of NH₄F, produce any product insoluble in CH₂Cl₂ and there was 40% of insoluble product in the dichloroethane for the 40% samples. For the 40% samples, the insoluble fractions were washed in methanol and the same method was used for pure TEOS. Two 40% TEOS samples, one 10% TEOS sample and pure TEOS were synthesized using the same catalyst. After polycondensation over a period of 48 h at 60° C. in the oven, the PTES/TEOS (90/10) and PTES/TEOS (60/40) samples were sulfonated by chlorosulfonic acid, which is introduced typically in the stoichiometry of 20% relative to PTES in dichloromethane. All of the products were immediately precipitated in the solvent. The results of testing of good or unsatisfactory solvents of sulfonated BTES/TEOS (90/10) are given in the following table 5:

TABLE 5

| Good Solvents | Non-Solvents |
|---|---|
| Ethyl alcohol | Water 25° C. |
| N,N-dimethylformamide dimethyl | Dichloroethane |
| acetal | |
| Methyl sulfoxide | |
| Boiling water | |

40% sulfonated PTES/TEOS does not dissolve in water, ethyl alcohol, dichloromethane, methyl alcohol and acetone. 40% sulfonated PTES/TEOS does not dissolve in water, ethyl alcohol, dichloromethane, methyl alcohol and acetone. Concentrated solutions of 10% sulfonated PTES/TEOS in the different good solvents were introduced into the space of the microporous silicon material by capillary action by depositing a 10 μL drop. The systems obtained in this fashion were left for one hour in the open air, then washed in distilled water for a period of 12 hours. For 40% PTES/TEOS, copolymerization en masse is done directly in the space of the tube by adding one 10 μL drop of the reaction mixture defined at the beginning of the example. The system obtained is sulfonated using trimethylsilylchlorosulfonate, 2 moles per kilogram of copolymer with an excess of 10 mole % in a glove box for a period of 12 hours by placing one 10 μL drop of the sulfonation agent on the microporous silicon material. The systems obtained in this fashion were left for one hour in the open air, then washed in distilled water for a period of 12 hours in order to obtain sulfonates.

### EXAMPLE 37

A polybenzylsilsesquioxane based on BTES was synthesized using NH₄F as the catalyst in the lumen of the microporous silicon material by placing one 10 μL drop of BTES with the half of its ethoxysilane hydrolysates and the catalyst. The silicon was previously oxidized to create surface silanols. Condensation was then done initially between the surface silanols and the BTES ethoxysilane and then between the BTES silanols and its ethoxysilane groups. The polyBETS formed is chemically linked to the wall of the microporosities and thus insoluble in the solvents. After 48 hours of reaction at room temperature, polycondensation is terminated by 48 hours of heating at 60° C. in an oven and then the system is washed in distilled water for a period of 24 hours. The microporous material is dried under vacuum at 100° C., then sulfonated using trimethylsilylchlorosulfonate, 3 moles per kilogram of copolymer with a 10 mole % excess, in the glove box over a period of 12 hours by placing a 10 μL drop of the sulfonation agent on the microporous silicon material. The systems obtained in this fashion are left for one hour in the open air, then washed in distilled water for a period of 12 hours in order to obtain the sulfonic acid groups. The protonic conductivity measured at 25° C. under 90% relative humidity is 50 mS/cm.

### EXAMPLE 38

A phenylsilsesquioxane based on PTES was synthesized using NH₄F as the catalyst in the lumen of the microporous silicon material by placing one 10 μL drop of PTES with half of its ethoxy hydrolysates and the catalyst. After 48 hours of reaction at room temperature, polycondensation is terminated by 48 hours of heating at 60° C. in an oven and then the microporous material is washed in distilled water for a period of 24 hours. The system is dried under vacuum at 100° C., then sulfonated using trimethylsilylchlorosulfonate, 2 moles per kilogram of copolymer with a 10 mole % excess, in the glove box over a period of 12 hours by placing a 10 μL drop of the sulfonation agent on the microporous silicon material. The systems obtained in this fashion were left for one hour in the open air, then washed in distilled water for a period of 12 hours in order to obtain sulfonates.

Second Preferred Embodiment.

In the first embodiment, the conduction of the protons can be approximated by the conductivity of the channels constituted by the three dimensional polymer chains. In the second preferred embodiment, the active surface for electrochemical exchanges is raised, by bonding the molecules to the inner surfaces of the channels.

Here is described an example of a method to obtain a membrane according to the second preferred embodiment.

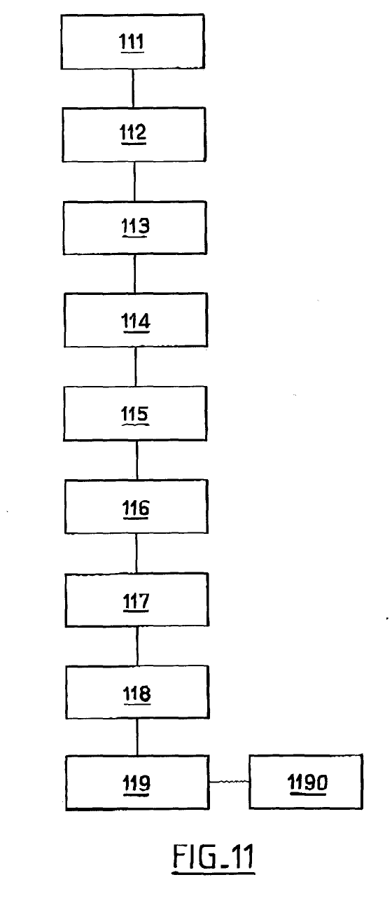

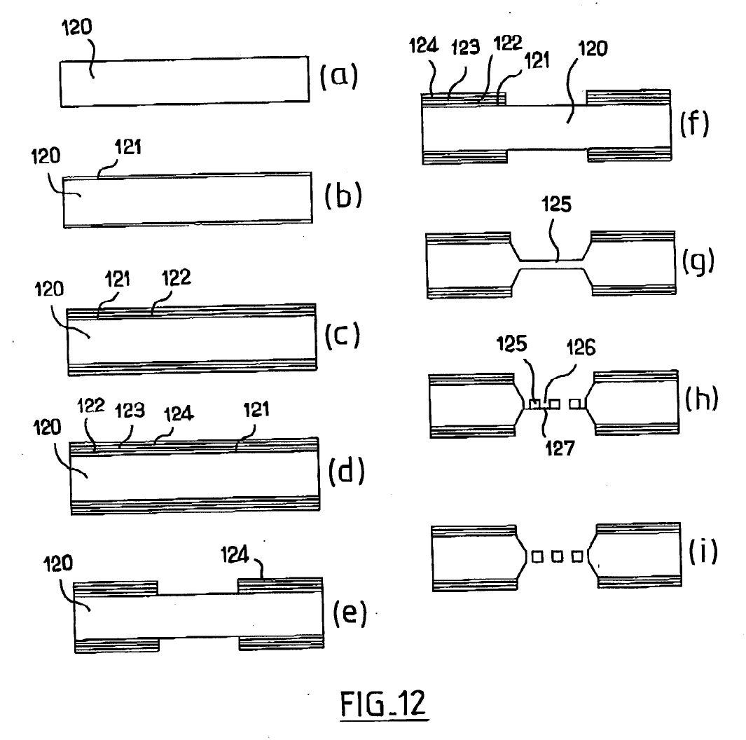

The different steps of the method are as follows, and are shown in FIG. 11 and FIG. 12.

In the first step 111 of FIG. 11, shown as well in FIG. 12(a), an N-type blank wafer 120 of silicon is prepared. The wafer 120 is <100> oriented, and the resistivity of the wafer 120 is from 0.02 _.cm for example.

In step 112, the wafer 120 is oxidized by a thermal oxidizing, in an oven, at a temperature of 1000° C. for instance. A flux of oxygen and water vapour flows in the oven has. The resulting layer of silicon oxide is referred to as 121 in FIG. 12(b).

In step 113 shown in FIG. 12(c), a layer 122 of chromium is coated on each surface of the wafer. The coating is conducted by cathodic spraying. The layer 122 has for example a thickness of 150 nm. This layer 122 serves as a layer of hanging-up for a layer 123 of gold. The layer of gold is for instance 1 μm-thick. The coating of the gold layer 123 is made thanks to a cathodic spraying as well.

In step 114, a photolithography is realised on the wafer 120, which has been metallized in step 113. The photolithography is realised on each of the surface thanks to a chromed glass mask. A photosensitive resin 124 is firstly coated on the wafer 120, above the gold layer 123, as shown in FIG. 12(d). The patterns of the mask are then reproduced by exposure of the resin 124 to ultraviolet radiation. The exposed parts of the resin 124 are then removed in an adapted solvent. The metal layer 123 is therefore bare on the desired locations for the membranes.

In step 115, the bare patterns are then etched by adapted etching solutions. The layers of gold, chromium are etched. The result of the etching of the metal layers 122 and 123 is shown in FIG. 12(e). The silicon dioxide is then etched as well in an ammonium bifluoride (BHF) solution (7 vol. NH₄F 40%+1 vol HF 50%). The result of such an etching is shown in FIG. 12(f). The etching of the silicon membranes is done is a KOH solution, with a concentration of 41%. A 40 μm-thick membrane 125 is obtained in FIG. 12(g). The resin is removed at that stage.

In step 116, the drilling of the membrane 125 is done so as to make the membrane 125 porous. The drilling is made by classic anodisation. The container in which anodisation is conducted is a double tank container. The bath is composed of HF:ethanol. The proportions of each component can be, for instance, 1:1. The result of the drilling is shown in FIG. 11(h). The concentration of the HF is for instance 48%.

In a step 117, the aim is to open all the channels 126. At the end of step 116, all the channels 126 may not be open, as it is shown in FIG. 12(h) where some channels 126 are blocked by the wall 127. To reach such an aim, a plasma reactive etching is conducted on the rear surface of the wafer. Such an etching allows the removal of material off the wall 127 on a few hundreds of nm. All the channels 126 are then open, as it is shown in FIG. 12(i).

In step 118, the channels 126 are then made hydrophilic thanks to two successive treatments. The membrane 125 is firstly put in a solution containing 80% of sulphuric acid and 20% of hydrogen peroxide. The membrane stays in the solution during around 60 minutes. Secondly, the membrane is put in a container where each surface is exposed to ultraviolet rays and an ozone flux. The exposure of each surface lasts around 10 minutes.

In step 119, molecules (an acid silane for example) are bonded to the surfaces of the channels 126. The membrane is put in an acid silane solution to a concentration of 1% during 60 minutes for example.

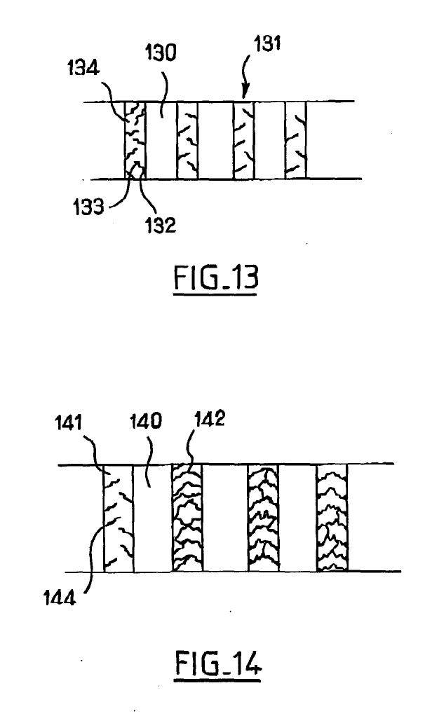

More generally, FIG. 13 is a schematic representation of the steps for the filling of channels by the proton conductive material. In FIG. 13, the channels 131 are drilled in the membrane 130 according to the method of anodisation just described above.

As for the first preferred embodiment as well, the proton conductive material 134 is introduced in the channels 131 of a membrane 130 under the form of a molecule or monomer. The molecule or monomer material 134 has different kinds of chemical groups. The monomers or molecules have on the one hand a “head” part 132 that can be bonded to the surface of the channels 131, and on the other hand a “tail” part 133 that is proton conductive. The typical size of the channels adapted to bonded molecules or monomers is under 10 nm and can be of the order of magnitude of 1 to 3 nm. It can be seen that the diameter of the channels is greatly reduced.

The active surface of the polymer is yet raised. The active surface for the conduction is now the whole inner surface of the channels 131, since it is coated with the proton conductive tails 133. Tails 133 are free to move in the channels 131. The conductivity of the membrane 130 is therefore greatly improved.

The monomer 134 that is introduced in the channels 131 is silicon compound.

The chemical bonding of active molecules on the inner surface of the channels of the porous silicon is now described.

The native layer of silicon dioxide in the channels 131 must have a sufficient thickness to allow the bonding of the monomer molecules. The chemical bonding is possible if the surface of the silicon dioxide has OH groups. The OH groups can be obtained on the surface of the silicon dioxide in the channels 131 if the membrane is put in a solution containing sulphuric acid and hydrogen peroxide, during 60 minutes for instance.

As already mentioned, the chemical molecules bonded on the inner surface of the channels 131 are silicon compounds having acid groups COOH, such as an acid silane (N-[trimethyloxysilylpropylethylenediamine] triacetic acid) or sulfonic groups (SO₃H), such as benzyltriethoxysilane after sulphonation.

During the bonding, the H of the OH group is removed from the channel surface, and an OR group of a silicon compound molecule (SiOR) is removed. Alcohol is formed when the two removed groups combine. A covalent bonding is formed between in the one hand the silicon compound and on the other hand the surface.

As most of the inner surface of the channels 131 is coated, the diameter of the channels 131 can be reduced without affecting the conduction active surface. The reduced diameters of the channels improve the tightness of the membrane to the fuel and oxidant.

Referring to FIG. 11 again, in step 1190, a thin layer of platinum is coated by cathodic spraying on each surface of the membrane. The thickness of the layer is equal to 1 to 2 nm. Each layer is therefore an electrode and a catalyst.

Now examples of molecules that can be used in the second preferred embodiment will be described.

On can use a monomer having the general formula Si(Cl)ₙ(CH₂)ₓ(C₆H₅)₄₋ₙ or the formula Si(OR)ₙ(CH₂)ₓ(C₆H₅)₄₋ₙ, where x can assume the values of 0 to 8 but preferably from 0 to 4, n can vary between 1 and 3, preferably between 2 and 3, R is an alkyl group of the general formula: CₙH₂ₙ₊₁. After condensation, total or partial, of the monomer with the surface silanols, the sulfonation reagent enabling substitution of the aromatic ring(s) by one or a plurality of sulfonic groups is introduced.

Examples 39 to 41 show the application of such molecules.

### EXAMPLE 39

Surface hydroxyls are created on the space of the microporous silicon material under ozone and ultraviolet. One 10 μL drop of BTES is placed on the silicon microporous material so that it wets the porosity by capillary action and it condenses on the space with the surface hydroxyls. After 48 hours of reaction at room temperature, polycondensation is terminated by 48 hours of heating at 60° C. in an oven and then the microporous material is washed in distilled water for a period of 24 hours. The system is dried under vacuum at 100° C., then sulfonated using trimethylsilylchlorosulfonate, 2 moles per kilogram of copolymer with a 10 mole % excess, in the glove box over a period of 12 hours by placing a 10 μL drop of the sulfonation agent on the microporous silicon material. The systems obtained in this fashion were left for one hour in the open air, then washed in distilled water for a period of 12 hours in order to obtain sulfonates.

### EXAMPLE 40

The purpose of this example is to functionalize the exposed surface in the microporous material with PTES then to sulfonate the aromatic rings. Surface hydroxyls are created on the space of the microporous silicon material under ozone and ultraviolet. One 10 μL drop of PTES is placed on the silicon microporous material so that it wets the porosity by capillary action and it condenses on the space with the surface hydroxyls. After 48 hours of reaction at room temperature, polycondensation is terminated by 48 hours of heating at 60° C. in an oven and then the microporous material is washed in distilled water for a period of 24 hours. The system is dried under vacuum at 100° C., then sulfonated using trimethylsilylchlorosulfonate, 2 moles per kilogram of copolymer with a 10 mole % excess, in the glove box over a period of 12 hours by placing a 10 μL drop of the sulfonation agent on the microporous silicon material. The systems obtained in this fashion were left for one hour in the open air, then washed in distilled water for a period of 12 hours in order to obtain sulfonates.

### EXAMPLE 41

Surface hydroxyls are created on the space of the microporous silicon material under ozone and ultraviolet. One 10 μL drop of BTES/PTES (25/75; 50/50 and 75/25 in moles) is placed on the silicon microporous material so that it wets the porosity by capillary action and condenses on the space with the surface hydroxyls. After 48 hours of reaction at room temperature, polycondensation is terminated by 48 hours of heating at 60° C. in an oven and then the microporous material is washed in distilled water for a period of 24 hours. The system is dried under vacuum at 100° C., then sulfonated using trimethylsilylchlorosulfonate, 2 moles per kilogram of copolymer with a 10 mole % excess, in the glove box over a period of 12 hours by placing a 10 μL drop of the sulfonation agent on the microporous silicon material. The systems obtained in this fashion were left for one hour in the open air, then washed in distilled water for a period of 12 hours in order to obtain sulfonates.

According to other embodiments, OH groups are still eliminated after the filling of the channels.

It is possible to simultaneously introduce into the porosity monomers of the Si(Cl)ₙ(CH₂)ₓ(C₆H₅)₄₋ₙ or of the Si(OR)ₙ(CH₂)ₓ(C₆H₅)₄₋ₙ type with the same assumption for x and n as in examples 39 to 41 and other monomers of the Si(Cl)ₙ−R₄₋ₙ′ or Si(OR)ₙR₄₋ₙ′ type, wherein R′ can be an alkyl CnH2n+1 or alkenyl CnH₂ₙ₋₁. After condensation, total or partial, of the monomer with the surface silanols, the sulfonation reagent enabling substitution of the aromatic ring(s) by one or a plurality of sulfonic groups is introduced.

Examples 42 and 43 show the application of such molecules.

### EXAMPLE 42

Surface hydroxyls are created on the space of the microporous silicon material under ozone and ultraviolet. One 10 μL drop of BTES is placed on the silicon microporous material so that it wets the porosity by capillary action and it condenses on the space with the surface hydroxyls. After 48 hours of reaction at room temperature, polycondensation is terminated over a period of 48 hours at 60° C. in an oven then the uncondensed hydroxyls are fixed by the addition of a drop of ClTMS on the microporous material, which is then washed in distilled water over a period of 24 hours. The system is dried under vacuum at 100° C., then sulfonated using trimethylsilylchlorosulfonate, 2 moles per kilogram of copolymer with a 10 mole % excess, in the glove box over a period of 12 hours by placing a 10 μL drop of the sulfonation agent on the microporous silicon material. The systems obtained in this fashion were left for one hour in the open air, then washed in distilled water for a period of 12 hours in order to obtain sulfonates.

### EXAMPLE 43

Surface hydroxyls are created on the space of the microporous silicon material under ozone and ultraviolet. One 10 μL drop of PTES is placed on the silicon microporous material so that it wets the porosity by capillary action and it condenses on the space with the surface hydroxyls. After 48 hours of reaction at room temperature, polycondensation is terminated over a period of 48 hours at 60° C. in an oven then the uncondensed hydroxyls are fixed by the addition of a drop of ClTMS on the microporous material, which is then washed in distilled water over a period of 24 hours. The system is dried under vacuum at 100° C., then sulfonated using trimethylsilylchlorosulfonate, 2 moles per kilogram of copolymer with a 10 mole % excess, in the glove box over a period of 12 hours by placing a 10 μL drop of the sulfonation agent on the microporous silicon material. The systems obtained in this fashion were left for one hour in the open air, then washed in distilled water for a period of 12 hours in order to obtain sulfonates.

Third Preferred Embodiment.

FIG. 14 represents schematically another embodiment of the present invention. In this embodiment, the membrane 140 is similar to the membranes of the other preferred embodiments, and the channels 141 are drilled by anodisation, as in the second preferred embodiment for instance. The monomer 144 that is introduced in the channels 141 is of the same type as the monomer introduced in the second preferred embodiment. It has a head that can be bonded to the inner surface of the channels 141 and a tail that can conduct protons. The monomer 144 that is introduced in the channels 141 is a silicon compound having acid groups (COOH) or SO₃H (obtained by sulphonation). The examples 39 to 43 can be referred to as well to define the molecules that can be used in the embodiment.

The difference between the third preferred embodiment and the second preferred embodiment is that, in the third preferred embodiment, the tails of the molecules of monomers are cross-linked after being bonded as it is shown is channel 142.

The cross-linking is made thanks to the use of heat and/or catalysts in the solution.

Therefore, the material in the channels 142 is still proton conductive, but the channels 142 are blocked by the cross-linking of the tails of the molecules. Therefore, the tightness of the membrane to the fuel and/or the fuel oxidant is raised. It is specifically true with if the fuel is an alcohol.

After the steps of cross-linking, the steps for the making of the electrodes and the catalysts are still the same as for the other embodiments.

Generalization.

In the above-mentioned examples, the method for anodisation in the method for making the first preferred embodiment is applicable as well to the method for making the second or third preferred embodiment, and reciprocally.

Of course, any combination of the embodiments for the membrane is possible. A first example is that a long polymer can be introduced in the channels after a monomer has been introduced. The monomer can be therefore cross-linked to the polymer and/or to the monomers as wanted. According to a second example, molecules and/or monomers can also be bonded to the inner surface of the channels, and a polymer and/or monomer can be introduced in the channels after that. The bonded molecules and/or monomers can be cross-linked to each other and/or to the polymer and/or to the monomer as wanted. According to a third example, a polymer and/or a monomer can be introduced in channels where molecules are bonded and crossed-linked already. The monomers can be cross-linked between them and/or to the bonded and cross-linked polymers. It is understood that a man skilled in the art will imagine other possibilities that the three cited examples, without leaving the scope of the invention.

The preferred embodiments refer only to the making of the membrane and do not refer to the structure of the cell. That means that the membrane can be as shown in FIG. 4a. The membrane is constituted at the level of the cell elements 5 by a complex of basic membranes 12 separated by metal layers 13, the whole being passed through by micro-channels 11 which ensure the passage of the protons. The preferred embodiments of the membrane can be in a cell or an apparatus according to FIGS. 1 to 6.

1. Fuel cell including a complex (3c) comprising an oxygen electrode (8a) and a fuel electrode (8b) surrounding a membrane (11) composed of a microporous medium impregnated with an electrolytic polymer, said cell being fed by an air source and a fuel source, wherein the microporous medium is made of a semiconductor material, this microporous medium having a plurality of microporous cell elements delimited between each other by recesses and in that the electrode and membrane complex comprising a plurality of cell elements is encapsulated between two exchanger/distributor components, one of these components comprising means for receiving a fuel cartridge.

2. Cell according to claim 1, wherein the microporous medium is made of oxidised silicon.

3. Cell according to claim 1, wherein the electrolytic polymer is Nafion® 117 or an equivalent polymer.

4. Cell according to claim 1, wherein the electrodes (8a and 8b) are composed of platinum, gold or a conductive mask obtained by thin layer deposition techniques.

5. Cell according to claim 1, wherein the electrodes are made of a highly conductive metal.

6. Cell according to claim 1, wherein the electrodes (8a and 8b) are coated with a catalyst composed of Platinum or Platinum/Ruthenium.

7. Cell according to claim 1, wherein the fuel is an alcohol, like methanol.

8. Cell according to claim 7, wherein the fuel is methanol diluted in water.

9. Cell according to claim 1, wherein the membrane is composed of a stack of basic membranes separated by Palladium type metal layers permeable to H² protons and impermeable to Methanol so as to improve the seal tightness of the membrane to Methanol.

10. Use of the cell according to one of the previous claims in telecommunications devices.

11. Use of the cell according to one of the previous claims in automobile equipment.

12. An electrolytic membrane of a fuel cell comprising a microporous silicon membrane wherein channels comprise a proton conductive material.

13. A membrane according to claim 12, wherein the proton conductive material comprises a polymeric material.

14. A membrane according to claim 13, wherein the polymeric material is selected from the group consisting of perfluorinated polyelectrolytic polymers bearing a sulfonic function and perfluorinated polyelectrolytic polymers bearing a carboxylic function.

15. A membrane according to claim 13, wherein the polymeric material is a polyelectrolytic polymer with an aromatic skeleton selected from the group consisting of polysulfones, polyethersulfones, polyether-ether-ketones, polyphenylene oxides and polyphenylenesulfides.

16. A membrane according to claim 15, wherein the aromatic skeleton comprises at least one ionic group selected from the group consisting of sulfonic groups, phosphonic groups and carboxylic groups.

17. A membrane according to claim 16, wherein the aromatic skeleton comprises several different ionic groups.

18. A membrane according to claim 12, wherein the proton conductive material comprises a monomer or an oligomer material that is cross-linked once in the channels.

19. A membrane according to claim 18, wherein the monomer or oligomer material comprises a polysiloxane skeleton bearing at least one sulfonic function.

20. A membrane according to claim 18, wherein the monomer or oligomer material is added with at least one ionic group selected from the group consisting of, sulfonic groups, phosphonic groups and carboxylic groups once in the channels.

21. A membrane according to claim 12, wherein the material comprises molecules bonded to the inner surface of the channels.

22. A membrane according to claim 21, wherein the proton conductive molecules comprise bonded monomers.

23. A membrane according to claim 22, wherein the monomers comprise a derivative selected from the group consisting of silanes and silicon compounds.

24. A membrane according to claim 23, wherein the monomer has a formula selected from the group consisting of Si(Cl)ₙ(CH₂)ₓ(C₆H₅)₄₋ₙ and Si(OR)ₙ(CH₂)ₓ(C₆H₅)₄₋ₙ, wherein x can assume the values of 0 to 8 but preferably from 0 to 4, n can vary between 1 and 3, preferably between 2 and 3, R is an alkyl group of the general formula: CₙH₂ₙ₊₁.

25. A membrane according to claim 24, wherein the channels comprise other monomers selected from the group consisting of Si(Cl)ₙR₄₋ₙ′ and Si (OR)ₙR₄₋ₙ′, wherein R′ can be an alkyl CnH2n+1 or an alkenyl CₙH₂ₙ₋₁.

26. A membrane according to claim 21, wherein the monomer molecules are bonded and cross-linked.

27. A membrane according to claim 12, wherein the channels have a diameter between 1 and 10 nm.

28. A membrane according to claim 12 comprising a thin layer of platinum on the two surfaces of the silicon porous membrane.

29. A membrane according to claim 28, wherein the layer of platinum is from 1 to 2 nm thick.

30. A membrane according to claim 12, wherein the channels at the centre of the membrane have a small diameter and the channels on the outer surface of the membrane have a larger diameter.

31. Method for making a microporous silicon membrane of a fuel cell comprising a proton conductive material in channels defining the permeability of the membrane, comprising the steps of:
using a wafer of doped and oxidized silicon;
making of the porous silicon by anodisation in a solution;
introducing a proton conductive material in channels made by the anodisation.

32. Method according to claim 31, wherein it comprises the step of introducing a sulfonated polymer in the channels.

33. Method according to claim 32, wherein the polymer solutions of 5 to 20 mass-% by weight in water/alcohol solvents are introduced in several steps, and wherein, after passage of each solution, the porous material is heated to eliminate the alcohols.

34. Method according to claim 31, wherein the sulphonation is done once the material is in the channels, the reagent enabling introduction of the ionic group on the material being introduced into the porosities after the filling of the porosity using the polymer solution.

35. Method according to claim 31, wherein it comprises the step of introducing a monomer or oligomer in the channels.

36. Method according to claim 35, wherein the a monomer or oligomer is in the form of acid or alkali, in concentrated solution or in molten form.

37. Method according to claim 35, wherein the monomer or oligomer is introduced in the channels in the presence of an initiator enabling post-polymerization after filling the porosity.

38. Method according to claim 37, wherein the cross-linking is induced by the phenomena selected from the group consisting of heating above the temperature of decomposition of the initiator, UV irradiation and electron bombardment.

39. Method according to claim 35, wherein the cross-linking is done after the filling of the channels, the reagent enabling introduction of the ionic group being introduced into the porosity after the material.

40. Method according to claim 35, wherein it comprises the step of bonding the molecules of the material to the inner surface of the channels.

41. Method according to claim 40, wherein the introducing of the conductive material is made by impregnation by capillarity.

42. Method according to claim 40, wherein the monomer or oligomer comprises at least an aromatic ring.

43. Method according to claim 42, wherein, after the bonding, total or partial, of the monomer with the surface, the sulfonation reagent enabling substitution of the at least aromatic ring by at least a sulfonic group is introduced.

44. Method according to claim 42, wherein it comprises the step of introducing into the porosity monomers selected from the group consisting of Si(Cl)ₙR₄₋ₙ′ and Si(OR)ₙR₄₋ₙ′ wherein R′ can be an alkyl CnH2n+1 or an alkenyl CₙH₂ₙ₋₁.

45. Method according to claim 44, wherein, after the bonding, total or partial, of the monomer with the surface, the sulfonation reagent enabling substitution of the at least aromatic ring by at least a sulfonic group is introduced.

46. Method according to claim 31, wherein anodisation is processed in a solution comprising hydrofluoric acid/water/ethanol.

47. Method according to claim 31, wherein anodisation is added with an etching of the rear surface of the membrane, so as to allow the piercing of all the channels.

48. Method according to claim 47, wherein the etching is a plasma reactive etching.

49. Method according to claim 31, wherein before introducing the conductive material, the channels are then made hydrophilic by fixing OH groups on the inner surface of the channels.

50. Method according to claim 49, wherein the steps to make the channels hydrophilic are:
putting the membrane in a solution containing 80% of sulphuric acid and 20% of hydrogen dioxide during around 60 minutes;
putting the membrane in a container where each surface is exposed to ultraviolet rays and an ozone flux during around 10 minutes.

51. Method according to claim 31, wherein the material comprises molecules selected from the group consisting of silanes and silicon compounds.

52. Method according to claim 40, wherein before the bonding of molecules, OH groups are fixed to the inner surface of the channels.

53. Method according to claim 31, wherein the membrane is put in an acid silane solution to a concentration of 1% during 60 minutes.

54. Method according to claim 40, wherein monomers and/or polymers are added in the channels after the bonding of the first molecules.

55. Method according to claim 54, wherein the monomers and/or polymers are cross-linked to each other and/or to the bonded molecules.

56. Method according to claim 31, wherein the surfaces of the membrane are coated by a catalyst.

57. Method according to claim 56, wherein the catalyst is a thin layer of platinum, which is coated by cathodic spraying.

58. Method according to claim 40, wherein the molecules are cross-linked between each other once in the channels.

59. Use of the cell membrane according to one of claims 12 to 30 in telecommunication devices.
